(19) United States
(12) Patent Application Publication
(10) Pub. No.: US 2025/0317987 A1
(43) Pub. Date: Oct. 9, 2025

(54) RANDOM ACCESS CHANNEL CONFIGURATION FOR FULL DUPLEX COMMUNICATIONS

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Abdelrahman Mohamed IBRAHIM, San Diego, CA (US)

(21) Appl. No.: 19/094,644

(22) Filed: Mar. 28, 2025

Related U.S. Application Data
(60) Provisional application No. 63/575,226, filed on Apr. 5, 2024.

(51) Int. Cl. H04W 74/0833; H04L 5/14; H04W 72/0446

(52) U.S. Cl. CPC H04W 74/0833; H04L 5/14; H04W 72/0446

(57) ABSTRACT

Methods, systems, and devices for wireless communications are described that provide for random access occasions (ROs) in full-duplex slots in addition to ROs in non-full-duplex time division duplexing (TDD) slots. The additional ROs may be provided for full-duplex slots based on TDD slots that are configured in a physical random access channel (PRACH) configuration. A user equipment (UE) may identify configured TDD PRACH slots within a subset of non-full-duplex slots that are configured with ROs, and identify the full-duplex slots with additional ROs relative the configured TDD PRACH slots based on a time offset, a frequency offset, or both. The UE may transmit one or more random access messages using one or more of the additional ROs in a full-duplex slot.

### CROSS REFERENCE

The present application for patent claims the benefit of Provisional Patent Application No. 63/575,226 by ABDELGHAFFAR et al., entitled “RANDOM ACCESS CHANNEL CONFIGURATION FOR FULL DUPLEX COMMUNICATIONS,” filed Apr. 5, 2024, assigned to the assignee hereof and hereby expressly incorporated by reference herein.

### FIELD OF TECHNOLOGY

The following relates to wireless communications, including random access channel configuration for full duplex communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access channel configuration for full duplex communications. For example, the described techniques provide random access occasions (ROs) in full-duplex slots in addition to ROs in non-full-duplex time division duplexing (TDD) slots. In some aspects, the additional ROs may be provided for full-duplex slots based on TDD slots that are configured in a physical random access channel (PRACH) configuration. In some cases, a user equipment (UE) may identify configured TDD PRACH slots within a subset of non-full-duplex slots that are configured with ROs, and identify the full-duplex slots with additional ROs relative the configured TDD PRACH slots based on a time offset, a frequency offset, or both. The UE may transmit one or more random access messages using one or more of the additional ROs in a full-duplex slot.

A method for wireless communication by a UE is described. The method may include receiving a first signal that indicates a random access channel configuration associated with a set of non-full-duplex slots, the random access channel configuration indicating a first subset of non-full-duplex slots of the set of non-full-duplex slots that include resources for one or more random access occasions, receiving a second signal that indicates a full-duplex configuration that indicates a set of full-duplex slots, where slots of the set of full-duplex slots are non-overlapping with slots of the set of non-full-duplex slots, and transmitting a random access message in at least a first full-duplex slot of the set of full-duplex slots, where time resources and frequency resources for the random access message in the first full-duplex slot are identified based on the random access channel configuration associated with the set of non-full-duplex slots.

A UE for wireless communication is described. The UE may include one or more memories storing processor executable code, and one or more processors coupled with the one or more memories. The one or more processors may individually or collectively be operable to execute the code to cause the UE to receive a first signal that indicates a random access channel configuration associated with a set of non-full-duplex slots, the random access channel configuration indicating a first subset of non-full-duplex slots of the set of non-full-duplex slots that include resources for one or more random access occasions, receive a second signal that indicates a full-duplex configuration that indicates a set of full-duplex slots, where slots of the set of full-duplex slots are non-overlapping with slots of the set of non-full-duplex slots, and transmit a random access message in at least a first full-duplex slot of the set of full-duplex slots, where time resources and frequency resources for the random access message in the first full-duplex slot are identified based on the random access channel configuration associated with the set of non-full-duplex slots.

Another UE for wireless communication is described. The UE may include means for receiving a first signal that indicates a random access channel configuration associated with a set of non-full-duplex slots, the random access channel configuration indicating a first subset of non-full-duplex slots of the set of non-full-duplex slots that include resources for one or more random access occasions, means for receiving a second signal that indicates a full-duplex configuration that indicates a set of full-duplex slots, where slots of the set of full-duplex slots are non-overlapping with slots of the set of non-full-duplex slots, and means for transmitting a random access message in at least a first full-duplex slot of the set of full-duplex slots, where time resources and frequency resources for the random access message in the first full-duplex slot are identified based on the random access channel configuration associated with the set of non-full-duplex slots.

A non-transitory computer-readable medium storing code for wireless communication is described. The code may include instructions executable by one or more processors to receive a first signal that indicates a random access channel configuration associated with a set of non-full-duplex slots, the random access channel configuration indicating a first subset of non-full-duplex slots of the set of non-full-duplex slots that include resources for one or more random access occasions, receive a second signal that indicates a full-duplex configuration that indicates a set of full-duplex slots, where slots of the set of full-duplex slots are non-overlapping with slots of the set of non-full-duplex slots, and transmit a random access message in at least a first full-duplex slot of the set of full-duplex slots, where time resources and frequency resources for the random access message in the first full-duplex slot are identified based on the random access channel configuration associated with the set of non-full-duplex slots.

In some examples of the method, UEs, and non-transitory computer-readable medium described herein, identifying, based on a time offset from one or more slots of the first subset of non-full-duplex slots, a second subset of full-duplex slots within the set of full-duplex slots that include one or more random access occasions that are available for transmission of the random access message.

In some examples of the method, UEs, and non-transitory computer-readable medium described herein, the second subset of full-duplex slots is identified based on a mapping from the first subset of non-full-duplex slots, and where the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots.

Some examples of the method, UEs, and non-transitory computer-readable medium described herein may further include operations, features, means, or instructions for determining a location of the first full-duplex slot based on a time offset from a non-full-duplex slot of the first subset of non-full-duplex slots, and where the time offset includes the non-full-duplex slot or start from a subsequent slot to the non-full-duplex slot. In some examples of the method, UEs, and non-transitory computer-readable medium described herein, the set of full-duplex slots includes at least two full-duplex slots that are mapped to a first non-full-duplex slot of the first subset of non-full-duplex slots.

Some examples of the method, UEs, and non-transitory computer-readable medium described herein may further include operations, features, means, or instructions for determining a location of the first full-duplex slot based on a time offset from a non-full-duplex slot of the first subset of non-full-duplex slots, and where the time offset indicates a quantity of physical slots relative to the non-full-duplex slot or a quantity of available full-duplex slots relative to the second non-full-duplex slot. In some examples of the method, UEs, and non-transitory computer-readable medium described herein, the time offset indicates a positive or negative quantity of slots relative to the second non-full-duplex slot.

Some examples of the method, UEs, and non-transitory computer-readable medium described herein may further include operations, features, means, or instructions for identifying one or more random access occasions in the first full-duplex slot based on a time offset from a random access channel occasion in a first non-full-duplex slot of the first subset of non-full-duplex slots, where the first full-duplex slot includes the one or more random access occasions irrespective of whether the first non-full-duplex slot is a valid uplink slot.

Some examples of the method, UEs, and non-transitory computer-readable medium described herein may further include operations, features, means, or instructions for determining a location of the one or more random access occasions in the first full-duplex slot based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots.

Some examples of the method, UEs, and non-transitory computer-readable medium described herein may further include operations, features, means, or instructions for identifying one or more random access occasions for a random access channel transmission in the first full-duplex slot based on a time offset only from a valid random access occasion in the first subset of non-full-duplex slots. Some examples of the method, UEs, and non-transitory computer-readable medium described herein may further include operations, features, means, or instructions for determining a location of the one or more random access occasions in the first full-duplex slot based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots.

Some examples of the method, UEs, and non-transitory computer-readable medium described herein may further include operations, features, means, or instructions for determining a location of the first full-duplex slot based on a time offset from a non-full-duplex slot of the first subset of non-full-duplex slots, and where the time offset is a defined offset value or is provided to the UE in the random access channel configuration. Some examples of the method, UEs, and non-transitory computer-readable medium described herein may further include operations, features, means, or instructions for determining a location of the frequency resources for the random access message in the first full-duplex slot based on a frequency offset associated with an uplink sub-band of the first full-duplex slot, and where the frequency offset corresponds to a first physical resource block of the uplink sub-band of the first full-duplex slot, or the frequency offset is provided to the UE in the random access channel configuration.

In some examples of the method, UEs, and non-transitory computer-readable medium described herein, the first full-duplex slot includes an uplink sub-band that includes frequency resources for at least two random access occasions, the random access message transmitted using frequency resources of one of the at least two random access occasions, and where, the at least two random access occasions are frequency division multiplexed within the uplink sub-band in accordance with a frequency division multiplexing configuration provided with the random access channel configuration associated with a set of non-full-duplex slots, the at least two random access occasions are frequency division multiplexed within the uplink sub-band based on a bandwidth of the uplink sub-band, and the at least two random access occasions are frequency division multiplexed within the uplink sub-band in accordance with a frequency division multiplexing configuration provided with the full-duplex configuration.

Some examples of the method, UEs, and non-transitory computer-readable medium described herein may further include operations, features, means, or instructions for formatting a sequence of the random access message in accordance with a same format indicated in the random access channel configuration, or in accordance with a format indicated in the full-duplex configuration. In some examples of the method, UEs, and non-transitory computer-readable medium described herein, a quantity of full-duplex slots of the set of full-duplex slots that are configured for transmission of the random access message is signaled to the UE, or is determined based on a quantity of non-full-duplex slots that are configured for transmission of random access messages.

In some examples of the method, UEs, and non-transitory computer-readable medium described herein, a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots.

In some examples of the method, UEs, and non-transitory computer-readable medium described herein, a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

In some examples of the method, UEs, and non-transitory computer-readable medium described herein, a time duration of one or more random access occasions within the first full-duplex slot is a same duration as, or a different duration than, a time duration of the one or more random access occasions of the first subset of non-full-duplex slots, based on whether a same or different random access channel sequence is configured for full-duplex slots and non-full-duplex slots. In some examples of the method, UEs, and non-transitory computer-readable medium described herein, the first full-duplex slot includes time resources for two or more random access occasions and frequency resources for the two or more random access occasions, and where a time gap and a frequency gap between consecutive random access occasions are each zero unless configured to a non-zero value. Some examples of the method, UEs, and non-transitory computer-readable medium described herein may further include operations, features, means, or instructions for receiving mapping information that indicates a correspondence between one or more random access occasions within the first full-duplex slot and one or more synchronization signal blocks, and where the mapping information is provided separately from other mapping information associated with non-full-duplex slots.

Some examples of the method, UEs, and non-transitory computer-readable medium described herein may further include operations, features, means, or instructions for receiving mapping information that indicates a correspondence between one or more random access occasions and one or more synchronization signal blocks, and where the mapping information applies to both full-duplex slots and non-full-duplex slots. Some examples of the method, UEs, and non-transitory computer-readable medium described herein may further include operations, features, means, or instructions for transmitting a UE capability indication that the UE can identify the time resources and the frequency resources for the random access message in the first full-duplex slot based on the random access channel configuration associated with the set of non-full-duplex slots.

A method for wireless communication by a network entity is described. The method may include outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions, outputting, to the UE, a second signal that indicates a full-duplex configuration that indicates a set of full-duplex slots, where slots of the set of full-duplex slots are non-overlapping with slots of the set of non-full-duplex slots, and obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

A network entity for wireless communication is described. The network entity may include one or more memories storing processor executable code, and one or more processors coupled with the one or more memories. The one or more processors may individually or collectively be operable to execute the code to cause the network entity to output, to a UE, a first signal that indicates a random access channel configuration associated with a set of non-full-duplex slots, the random access channel configuration indicating a first subset of non-full-duplex slots of the set of non-full-duplex slots that include resources for one or more random access occasions, output, to the UE, a second signal that indicates a full-duplex configuration that indicates a set of full-duplex slots, where slots of the set of full-duplex slots are non-overlapping with slots of the set of non-full-duplex slots, and obtain, from the UE, a random access message in at least a first full-duplex slot of the set of full-duplex slots, where time resources and frequency resources for the random access message in the first full-duplex slot are identified based on the random access channel configuration associated with the set of non-full-duplex slots.

Another network entity for wireless communication is described. The network entity may include means for outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions, means for outputting, to the UE, a second signal that indicates a full-duplex configuration that indicates a set of full-duplex slots, where slots of the set of full-duplex slots are non-overlapping with slots of the set of non-full-duplex slots, and means for obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

A non-transitory computer-readable medium storing code for wireless communication is described. The code may include instructions executable by one or more processors to output, to a UE, a first signal that indicates a random access channel configuration associated with a set of non-full-duplex slots, the random access channel configuration indicating a first subset of non-full-duplex slots of the set of non-full-duplex slots that include resources for one or more random access occasions, output, to the UE, a second signal that indicates a full-duplex configuration that indicates a set of full-duplex slots, where slots of the set of full-duplex slots are non-overlapping with slots of the set of non-full-duplex slots, and obtain, from the UE, a random access message in at least a first full-duplex slot of the set of full-duplex slots, where time resources and frequency resources for the random access message in the first full-duplex slot are identified based on the random access channel configuration associated with the set of non-full-duplex slots.

In some examples of the method, network entities, and non-transitory computer-readable medium described herein, a second subset of full-duplex slots within the set of full-duplex slots include one or more random access occasions that are available for transmission of the random access message, and where the second subset of full-duplex slots is determined based on a time offset from one or more slots of the first subset of non-full-duplex slots.

In some examples of the method, network entities, and non-transitory computer-readable medium described herein, the second subset of full-duplex slots is identified based on a mapping from the first subset of non-full-duplex slots, and where the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots.

In some examples of the method, network entities, and non-transitory computer-readable medium described herein, a location of the first full-duplex slot is determined based on a time offset from a non-full-duplex slot of the first subset of non-full-duplex slots, and where time offset includes the non-full-duplex slot or start from a subsequent slot to the second non-full-duplex slot. In some examples of the method, network entities, and non-transitory computer-readable medium described herein, the set of full-duplex slots includes at least two full-duplex slots that are mapped to a first non-full-duplex slot of the first subset of non-full-duplex slots.

In some examples of the method, network entities, and non-transitory computer-readable medium described herein, a location of the first full-duplex slot is determined based on a time offset from a non-full-duplex slot of the first subset of non-full-duplex slots, and where the time offset indicates a quantity of physical slots relative to the non-full-duplex slot or a quantity of available full-duplex slots relative to the second non-full-duplex slot. In some examples of the method, network entities, and non-transitory computer-readable medium described herein, the time offset indicates a positive or negative quantity of slots relative to the second non-full-duplex slot.

In some examples of the method, network entities, and non-transitory computer-readable medium described herein, the first full-duplex slot includes one or more random access occasions that are determined based on a time offset from a random access channel occasion in a first non-full-duplex slot of the first subset of non-full-duplex slots, where the first full-duplex slot includes the one or more random access occasions irrespective of whether the first non-full-duplex slot is a valid uplink slot. In some examples of the method, network entities, and non-transitory computer-readable medium described herein, the first full-duplex slot includes one or more random access occasions for a random access channel transmission that are based on a time offset only from a valid random access occasion in the first subset of non-full-duplex slots.

In some examples of the method, network entities, and non-transitory computer-readable medium described herein, a location of the one or more random access occasions in the first full-duplex slot is based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots.

In some examples of the method, network entities, and non-transitory computer-readable medium described herein, a location of the first full-duplex slot is determined based on a time offset from a non-full-duplex slot of the first subset of non-full-duplex slots, and where the time offset is a defined offset value or is provided to the UE in the random access channel configuration. In some examples of the method, network entities, and non-transitory computer-readable medium described herein, a location of the frequency resources for the random access message in the first full-duplex slot is determined based on a frequency offset associated with an uplink sub-band of the first full-duplex slot, and where the frequency offset corresponds to a first physical resource block of the uplink sub-band of the first full-duplex slot, or the frequency offset is provided to the UE in the random access channel configuration.

In some examples of the method, network entities, and non-transitory computer-readable medium described herein, the first full-duplex slot includes an uplink sub-band that includes frequency resources for at least two random access occasions, the random access message transmitted using frequency resources of one of the at least two random access occasions, and where, the at least two random access occasions are frequency division multiplexed within the uplink sub-band in accordance with a frequency division multiplexing configuration provided with the random access channel configuration associated with a set of non-full-duplex slots, the at least two random access occasions are frequency division multiplexed within the uplink sub-band based on a bandwidth of the uplink sub-band, and the at least two random access occasions are frequency division multiplexed within the uplink sub-band in accordance with a frequency division multiplexing configuration provided with the full-duplex configuration.

In some examples of the method, network entities, and non-transitory computer-readable medium described herein, a sequence of the random access message is formatted in accordance with a same format indicated in the random access channel configuration, or in accordance with a format indicated in the full-duplex configuration. In some examples of the method, network entities, and non-transitory computer-readable medium described herein, a quantity of full-duplex slots of the set of full-duplex slots that are configured for transmission of the random access message is signaled to the UE, or is determined based on a quantity of non-full-duplex slots that are configured for transmission of random access messages.

In some examples of the method, network entities, and non-transitory computer-readable medium described herein, a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots.

In some examples of the method, network entities, and non-transitory computer-readable medium described herein, a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

In some examples of the method, network entities, and non-transitory computer-readable medium described herein, a time duration of one or more random access occasions within the first full-duplex slot is a same duration as, or a different duration than, a time duration of the one or more random access occasions of the first subset of non-full-duplex slots, based on whether a same or different random access channel sequence is configured for full-duplex slots and non-full-duplex slots.

In some examples of the method, network entities, and non-transitory computer-readable medium described herein, the first full-duplex slot includes time resources for two or more random access occasions and frequency resources for the two or more random access occasions, and where a time gap and a frequency gap between consecutive random access occasions are each zero unless configured to a non-zero value. Some examples of the method, network entities, and non-transitory computer-readable medium described herein may further include operations, features, means, or instructions for outputting mapping information that indicates a correspondence between one or more random access occasions within the first full-duplex slot and one or more synchronization signal blocks, and where the mapping information is provided separately from other mapping information associated with non-full-duplex slots. Some examples of the method, network entities, and non-transitory computer-readable medium described herein may further include operations, features, means, or instructions for outputting mapping information that indicates a correspondence between one or more random access occasions and one or more synchronization signal blocks, and where the mapping information applies to both full-duplex slots and non-full-duplex slots.

### BRIEF DESCRIPTION OF THE DRAWINGS

FIG. 1 shows an example of a wireless communications system that supports random access channel configuration for full duplex communications in accordance with one or more aspects of the present disclosure.

FIG. 2 shows an example of a wireless communications system that supports random access channel configuration for full duplex communications in accordance with one or more aspects of the present disclosure.

FIGS. 3 through 11 show examples of random access resources that support random access channel configuration for full duplex communications in accordance with one or more aspects of the present disclosure.

FIG. 12 shows an example of a process flow that supports random access channel configuration for full duplex communications in accordance with one or more aspects of the present disclosure.

FIGS. 13 and 14 show block diagrams of devices that support random access channel configuration for full duplex communications in accordance with one or more aspects of the present disclosure.

FIG. 15 shows a block diagram of a communications manager that supports random access channel configuration for full duplex communications in accordance with one or more aspects of the present disclosure.

FIG. 16 shows a diagram of a system including a device that supports random access channel configuration for full duplex communications in accordance with one or more aspects of the present disclosure.

FIGS. 17 and 18 show block diagrams of devices that support random access channel configuration for full duplex communications in accordance with one or more aspects of the present disclosure.

FIG. 19 shows a block diagram of a communications manager that supports random access channel configuration for full duplex communications in accordance with one or more aspects of the present disclosure.

FIG. 20 shows a diagram of a system including a device that supports random access channel configuration for full duplex communications in accordance with one or more aspects of the present disclosure.

FIGS. 21 through 25 show flowcharts illustrating methods that support random access channel configuration for full duplex communications in accordance with one or more aspects of the present disclosure.

### DETAILED DESCRIPTION

In some wireless communications systems, full-duplex communications techniques may be implemented in which a same set of wireless resources within a time division duplexing (TDD) radio frame are used for both uplink communications from a user equipment (UE) to a network entity and downlink communications from the network entity to one or more UEs. In some deployments, sub-band full-duplex (SBFD) may be used in which a set of frequency resources may include one or more uplink sub-bands and one or more downlink sub-bands that are non-overlapping. In other deployments, full-duplex communications techniques may include overlapping uplink and downlink frequency resources. Although various examples discussed herein illustrate SBFD resources, techniques provided herein may also be used in full-duplex communications in which uplink and downlink communications use overlapping frequency resources within a same time period. In some cases, a SBFD configuration may provide a set of SBFD slots within a TDD configuration, such that some slots within a TDD radio frame are SBFD slots and remaining slots within the TDD radio frame are non-full-duplex slots. In some cases, non-full-duplex slots may also be referred to as legacy slots.

In order to initiate communications between a UE and a network entity, a UE may transmit a random access message using random access resources that are configured in one or more uplink slots. In some cases, a physical random access channel (PRACH) configuration may be provided to a UE (e.g., via radio resource control (RRC) signaling) that identifies one or more uplink slots in a TDD radio frame that include one or more random access occasions (ROs). An RO may include time resources and frequency resources in which a network entity may monitor for random access messages from UEs. Existing techniques for PRACH configuration provide that ROs are configured only in non-full-duplex TDD slots. In accordance with various aspects discussed herein, ROs may also be provided in full-duplex slots that may be used by full-duplex-aware UEs (e.g., UEs that support full-duplex signaling) to transmit random access messages. Such techniques may help to enhance efficiency and reduce latency of wireless communications by allowing for additional ROs in additional slots compared to non-full-duplex ROs provided in a PRACH configuration.

In some aspects, additional ROs may be provided for full-duplex slots, where a location of the additional ROs may be based on TDD slots that are configured in a PRACH configuration. In some cases, a UE may identify configured TDD PRACH slots within a subset of non-full-duplex slots that are configured with ROs, and identify the full-duplex slots with additional ROs relative the configured TDD PRACH slots based on a time offset. In some cases, the association or mapping between ROs in the TDD PRACH slots and ROs in the full-duplex slots may be one-to-one or one-to-many, such that a TDD PRACH slot may be associated with one or more full-duplex slots with ROs. The time offset may be a default offset, or may be configured (e.g., through RRC signaling). In some aspects, the time offset may be based on configured TDD PRACH slots irrespective of whether a slot is a valid uplink slot (e.g., when a PRACH configuration provides ROs in a slot, but the slot is a downlink slot in a current TDD configuration, such a slot is a configured slot but not a valid slot). Within each full-duplex slot with ROs, there may be one or multiple ROs. The time offset may be based on symbols or slots, and may start with a TDD PRACH slot or a next slot following a TDD PRACH slot. Further, in some aspects, the time offset may be a positive or a negative offset. A frequency offset for an RO frequency resource in a full-duplex sub-band may be implicit, or may be configured (e.g., via RRC signaling). Additionally, or alternatively, a PRACH format and/or sequence for full-duplex ROs may be the same as, or different than, a TDD PRACH format and/or sequence.

Aspects of the disclosure are initially described in the context of wireless communications systems. Aspects of the disclosure are further illustrated by and described with reference to random access resource diagrams, process flows, apparatus diagrams, system diagrams, and flowcharts that relate to random access channel configuration for full duplex communications.

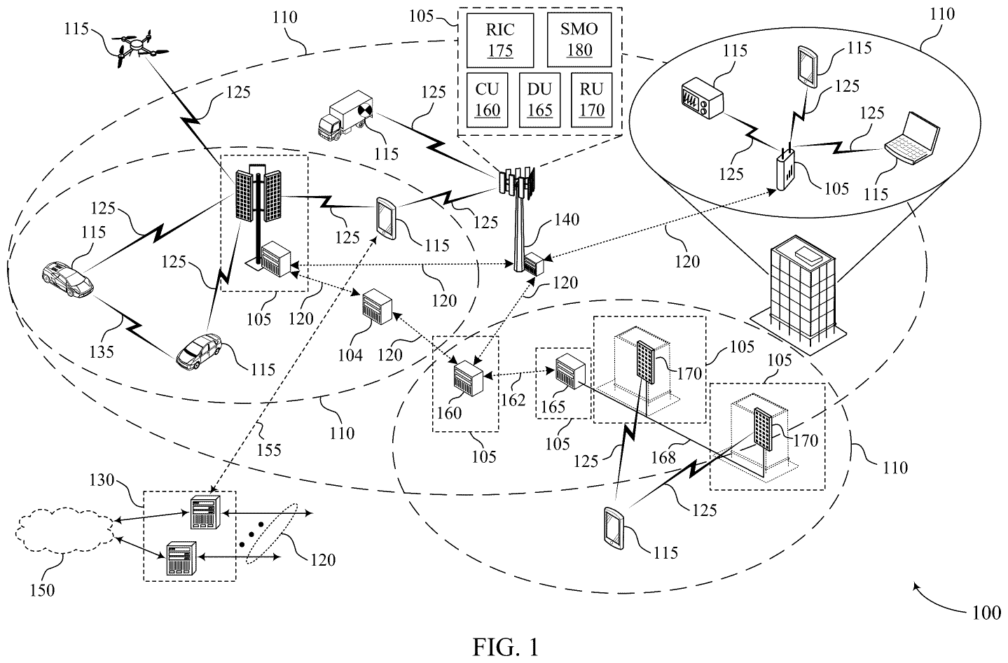

FIG. 1 shows an example of a wireless communications system 100 that supports random access channel configuration for full duplex communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, UEs 115 and network entities 105 may communicate using full-duplex communications in which a same set of wireless resources may be used for both uplink and downlink communications. For example, a subset of subframes of a TDD frame may be configured as full-duplex subframes such that the TDD frame includes full-duplex slots and non-full-duplex slots. In some cases, ROs may be configured in full-duplex slots in addition to ROs in non-full-duplex slots. In some cases, the additional ROs may be provided for full-duplex slots based on TDD slots that are configured in a PRACH configuration. In some cases, a UE 115 may identify configured TDD PRACH slots within a subset of non-full-duplex slots that are configured with ROs, and identify the full-duplex slots with additional ROs relative the configured TDD PRACH slots based on a time offset, a frequency offset, or both. The UE 115 may transmit one or more random access messages to a network entity 105 using one or more of the additional ROs in a full-duplex slot.

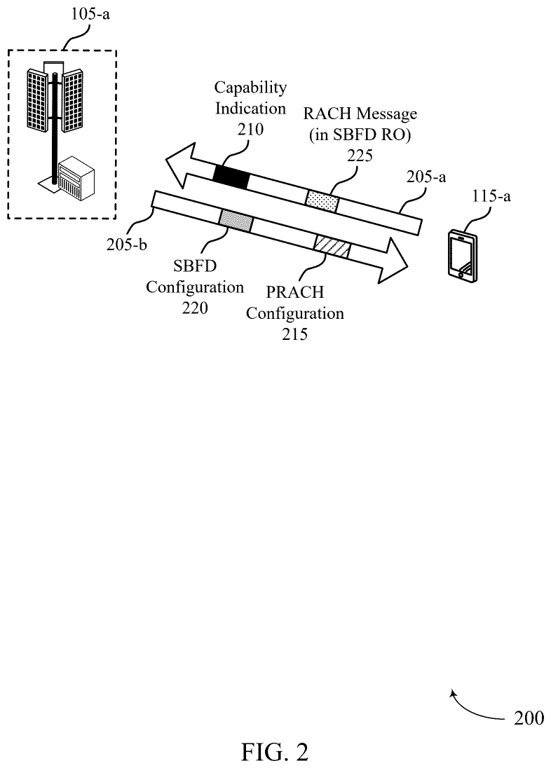

FIG. 2 shows an example of a wireless communications system 200 that supports random access channel configuration for full duplex communications in accordance with one or more aspects of the present disclosure. The wireless communications system 200 may implement or be implemented by aspects of the wireless communications system 100 as described herein with reference to FIG. 1. For example, the wireless communications system 200 may include a UE 115-a and a network entity 105-a, which may be an example of UEs 115 and network entities 105 as described herein with reference to FIG. 1. The wireless communications system 200 may support 3G, 4G, 5G, or radio access technologies beyond 5G.

The UE 115-a and the network entity 105-a may perform wireless communication (e.g., one or more of receiving, obtaining, transmitting, or outputting one or more of control information, configuration information, or data) via a communication link 205, including uplink communication link 205-a and downlink communication link 205-b, which may be examples of communications links 125 as described herein with reference to FIG. 1. In some cases, communication link 205 may include multiple component carriers. In the example of FIG. 2, the UE 115-a may be capable of having awareness of full-duplex operation by the network entity 105-a. In such examples, the UE 115-a may transmit a capability indication 210 to the network entity 105-a that indicates a full-duplex capabilities. For example, the capability indication 210 may indicate that the UE 115-a can identify the time resources and frequency resources for random access messages in full-duplex slots based on a PRACH configuration associated with non-full-duplex slots.

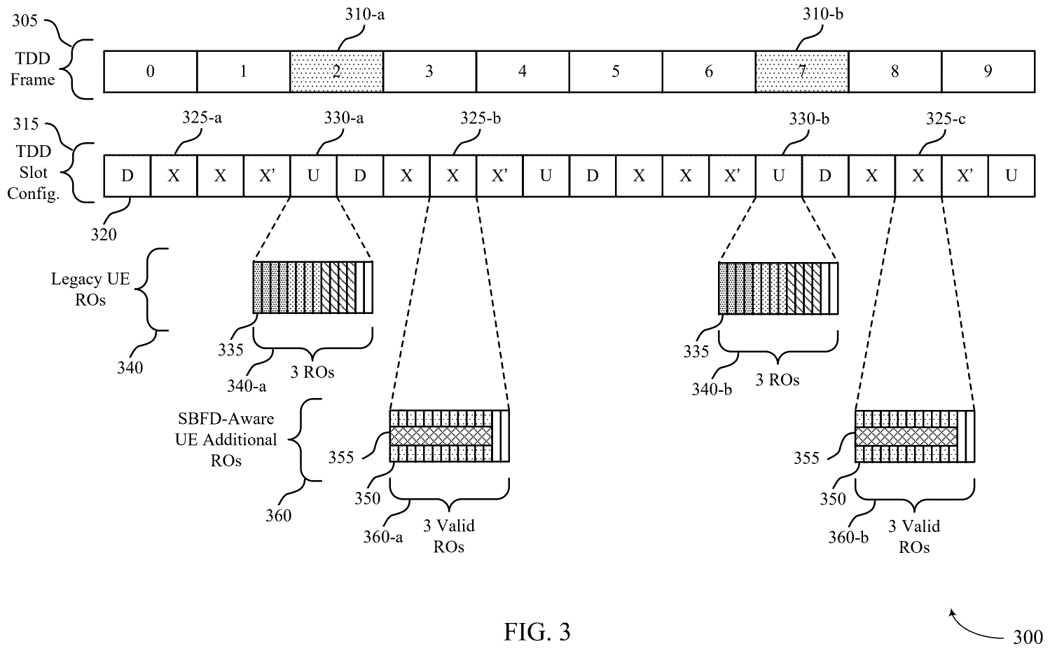

In some aspects, the network entity 105-a may transmit a PRACH configuration 215 to the UE 115-a, where the PRACH configuration 215 indicates TDD subframes that include ROs. In the example of FIG. 2, the network entity 105-a may transmit a SBFD configuration 220 to the UE 115-a, which may identify TDD subframes that are configured as SBFD subframes. In some aspects, additional ROs may be provided for full-duplex slots that are configured in the SBFD configuration 220, where a location of the additional ROs may be based on TDD slots that are configured in the PRACH configuration 215. The UE 115-a may transmit RACH message 225 using one or more of the additional ROs. In some cases, the UE 115-a may identify configured TDD PRACH slots within a subset of non-full-duplex slots that are configured with ROs, and identify the full-duplex slots with additional ROs relative the configured TDD PRACH slots based on a time offset. In some cases, the association or mapping between ROs in the TDD PRACH slots and ROs in the full-duplex slots may be one-to-one or one-to-many, such that a TDD PRACH slot may be associated with one or more full-duplex slots with ROs. The time offset may be a default offset, or may be configured (e.g., through RRC signaling). In some aspects, the time offset may be based on configured TDD PRACH slots irrespective of whether a slot is a valid uplink slot (e.g., when a PRACH configuration provides ROs in a slot, but the slot is a downlink slot in a current TDD configuration, such a slot is a configured slot but not a valid slot). Within each full-duplex slot with ROs, there may be one or multiple ROs. The time offset may be based on symbols or slots, and may start with a TDD PRACH slot or a next slot following a TDD PRACH slot. Further, in some aspects, the time offset may be a positive or a negative offset. A frequency offset for an RO frequency resource in a full-duplex sub-band may be implicit (e.g., interpreted based on one or more other parameters), or may be configured (e.g., via RRC signaling). Additionally, or alternatively, a PRACH format and/or sequence for full-duplex ROs may be the same as, or different than, a TDD PRACH format and/or sequence. In some cases, random access message repetition may be enabled across multiple ROs in full-duplex slots. FIGS. 3 through 11 provide examples of full-duplex ROs and RO locations based on TDD PRACH configurations in accordance with various aspects of the present disclosure.

FIG. 3 shows an example of a random access resources 300 that supports random access channel configuration for full duplex communications in accordance with one or more aspects of the present disclosure. In some cases, aspects of the random access resources 300 may implement or be implemented by aspects of a wireless communications system 100 or 200, as described with reference to FIGS. 1 and 2. For example, the random access resources 300 may be configured at network entity 105 and a UE 115, which may be examples of a network entity 105 and UE 115 as described with reference to FIGS. 1 and 2.

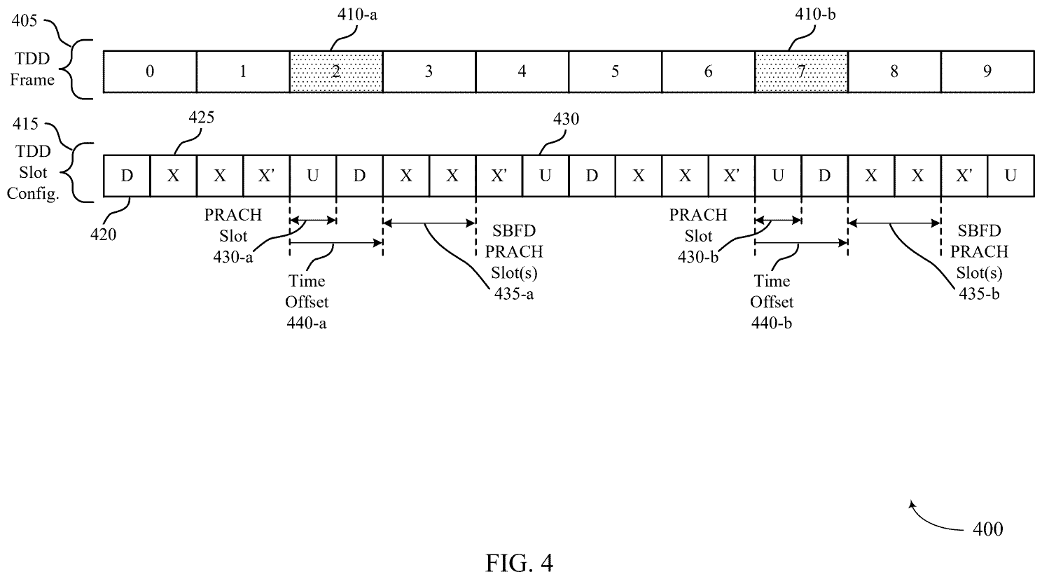

In this example, a TDD frame 305 may be configured with a TDD configuration. The TDD configuration may be indicated, for example, in system information broadcast by a network entity. The TDD frame 305 includes 10 subframes with two TDD slots per subframe assuming 30 kilohertz (KHz) numerology in this example (and in other examples in FIGS. 4 through 11). The slots may have a TDD slot configuration 315 that indicates a slot as a downlink slot 320, a SBFD slot 325, or an uplink slot 330. In this example, SBFD slots 325 (e.g., first SBFD slot 325-a) are indicated with an “X” in FIG. 3. In cases where a slot is configured with both SBFD symbols and non-SBFD symbols, such SBFD slots 325 are indicated with an “X′.” Within the TDD slot configuration 315, one or more uplink PRACH slots 330 may be configured, according to a PRACH configuration, with PRACH resources for one or more legacy UE ROs 340. In this example each legacy UE RO 340 may include four OFDM symbols 335 such that each configured uplink slot 330 includes three ROs 340. In the example of FIG. 3, the PRACH configuration may provide that a first uplink PRACH slot 330-a and a second uplink PRACH slot 330-b are configured with corresponding ROs 340-a and 340-b. In some aspects, the PRACH configuration may be indicated to a UE by a PRACH configuration index value that indicates resources within a TDD slot configuration 315 that are configured with ROs. For example, a UE may be provided with an indication of PRACH configuration index 102 for a TDD communications in FR1 with a 30 KHz subcarrier spacing (SCS) for an initial random access message (e.g., MSG1). Table 1 provides an example of information indicates for PRACH configuration index 102:

TABLE 1

| | | | | | | | Time | |
|---|---|---|---|---|---|---|---|---|
| | | | | | | Number | Domain | |
| | | | | | | for | PRACH | |
| PRACH | | n_{SFN} mode | | | | PRACH | Occasions within | |
| Configuration | Preamble | x = y | | Subframe | Starting | slots within | PRACH | PRACH |
| Index | Format | x | y | Number | Symbol | subframe | Slot | duration |
| 102 | A2 | 1 | 0 | 2.7 | 0 | 1 | 3 | 4 |

As can be observed from this example PRACH configuration, subframe number 2 310-a and subframe number 7 310-b are configured with legacy UE ROs 340, where the ROs start at an initial OFDM symbol 335 in a slot (e.g., OFDM symbol number 0), there is one PRACH uplink slot 330 within a subframe, there are three time domain legacy UE ROs 340 within each PRACH slot, and each RO has a duration of four OFDM symbols. It is to be understood that this example for PRACH configuration index 102 is provided for purposes of discussion and illustration, and that numerous different PRACH configurations may be used in accordance with techniques as discussed herein.

It is noted that the PRACH configuration may be provided independently of a TDD slot configuration, and in some cases a PRACH configuration index may indicate a PRACH slot that corresponds to a downlink slot in accordance with the TDD slot configuration. In such cases, the PRACH configuration indicates configured ROs in a slot, but such ROs are invalid due to the associated slot not being an uplink slot. A valid RO is one where the TDD slot configuration 315 indicates an uplink slot for the configured RO, and an invalid RO is one where the TDD slot configuration 315 indicates a downlink slot for the configured RO.

In the example of FIG. 3, a SBFD configuration may indicate a subset of slots of the TDD slot configuration 315 are configured as SBFD slots. In this example, SBFD slots 325 configured by the SBFD configuration may include a second SBFD slot 325-b and a third SBFD slot 325-c. In accordance with various aspects discussed herein, such SBFD slots 325 may include additional ROs 360 that may be available for random access message transmission by SBFD-aware UEs (e.g., UEs that support SBFD signaling). For example, SBFD slots 325 may be configured with downlink sub-bands 350 and uplink sub-band 355, where the uplink sub-band 355 may include three valid ROs 360, such that the second SBFD slot 325-b includes a first set of three valid ROs 360-a and the third SBFD slot 325-c includes a second set of three valid ROs 360-b. The SBFD-aware UE may then use the valid ROs 360 to transit a random access message. The time resources and frequency location of the SBFD valid ROs 360 may be determined based on one or more time offsets, frequency offsets, or both. FIGS. 4 through 12 illustrate various examples of RO locations based on time offsets, frequency offsets, or both, in accordance with various aspects provided herein. The one or more time offsets and/or frequency offsets may be indicated to the UE, for example, by RRC signaling for UE in a RRC-connected state or in a broadcast message (e.g., SIB1) to enable SBFD random access for RRC idle/inactive UE.

FIG. 4 shows an example of a random access resources 400 that supports random access channel configuration for full duplex communications in accordance with one or more aspects of the present disclosure. In some cases, aspects of the random access resources 400 may implement or be implemented by aspects of a wireless communications system 100 or 200, as described with reference to FIGS. 1 and 2. For example, the random access resources 400 may be configured at network entity 105 and a UE 115, which may be examples of a network entity 105 and UE 115 as described with reference to FIGS. 1 and 2.

In this example, a TDD frame 405 may be configured with a TDD configuration. The TDD configuration may be indicated, for example, in system information broadcast by a network entity. The TDD frame 405 includes 10 subframes with two slots per subframe, including first subframe 410-a and second subframe 410-b that are configured with PRACH ROS. The slots may have a TDD slot configuration 415 that indicates a slot as a downlink slot 420, or an uplink slot 430. In this example, one or more SBFD slots 425 are configured, indicated with an “X” or “X” as discussed with reference to FIG. 3. Within the TDD slot configuration 415, a first uplink slot 430-a and a second uplink slot 430-b may be configured (e.g., according to PRACH configuration index 102) with PRACH resources for one or more legacy UE ROs.

In this example, a SBFD configuration may indicate that slot 425 is configured as a SBFD slot, and additional ROs within the SBFD slots may be identified based on a time offset 440 from configured PRACH slots. For example, a first time offset 440-a may indicate a first set of SBFD PRACH slots 435-a based on first PRACH uplink slot 430-a configured by the PRACH configuration, and a second time offset 440-b may indicate a second set of SBFD PRACH slots 435-b based on second PRACH uplink slot 430-b configured by the PRACH configuration. Thus, in some aspects, one or more additional SBFD PRACH slots 435 are associated with the TDD PRACH slots 430 that are configured in the PRACH configuration. A UE may first identify the configured PRACH slots in non-full-duplex symbols, and then may identify the SBFD PRACH slots 435 relative the TDD PRACH slots 430 based on the time offset 440. The association or mapping between TDD PRACH slots 430 and SBFD PRACH slots 435 may be a 1-to-1 mapping or a 1-to-many mapping, such that each TDD PRACH slot 430 may be associated with one or more SBFD PRACH slots 435.

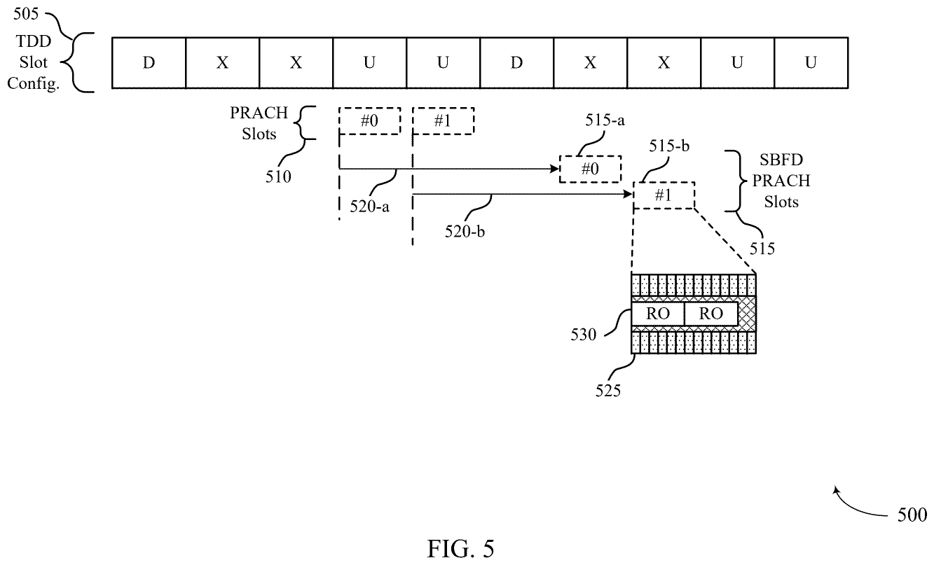

FIG. 5 shows an example of a random access resources 500 that supports random access channel configuration for full duplex communications in accordance with one or more aspects of the present disclosure. In some cases, aspects of the random access resources 500 may implement or be implemented by aspects of a wireless communications system 100 or 200, as described with reference to FIGS. 1 and 2. For example, the random access resources 500 may be configured at network entity 105 and a UE 115, which may be examples of a network entity 105 and UE 115 as described with reference to FIGS. 1 and 2.

In FIG. 5, a TDD slot configuration 505 may include downlink, and uplink slots. Further, some downlink or flexible slots may be configured as SBFD slots. In this example, a PRACH configuration may configure two TDD PRACH slots 510, and SBFD PRACH slots 515 may be determined based on a time offset 520 from the TDD PRACH slots 510. In this example, a first instance of time offset 520-a may indicate a first SBFD PRACH slot 515-a and a second instance of time offset 520-b may indicate a second SBFD PRACH slot 515-b. Each SBFD PRACH slot 515 may include downlink sub-bands 525 and an uplink sub-band 530 that includes two ROs, although more of fewer ROs may be present. Thus, in this example, additional SBFD PRACH slots 515 are associated with the TDD PRACH slots 510 based on time offset 520. In some aspects, the time offset 520 may start from the first symbol in the TDD PRACH slot 510 (counting the PRACH slot) or may start from the next symbol after the TDD PRACH slot (not counting the PRACH slot).

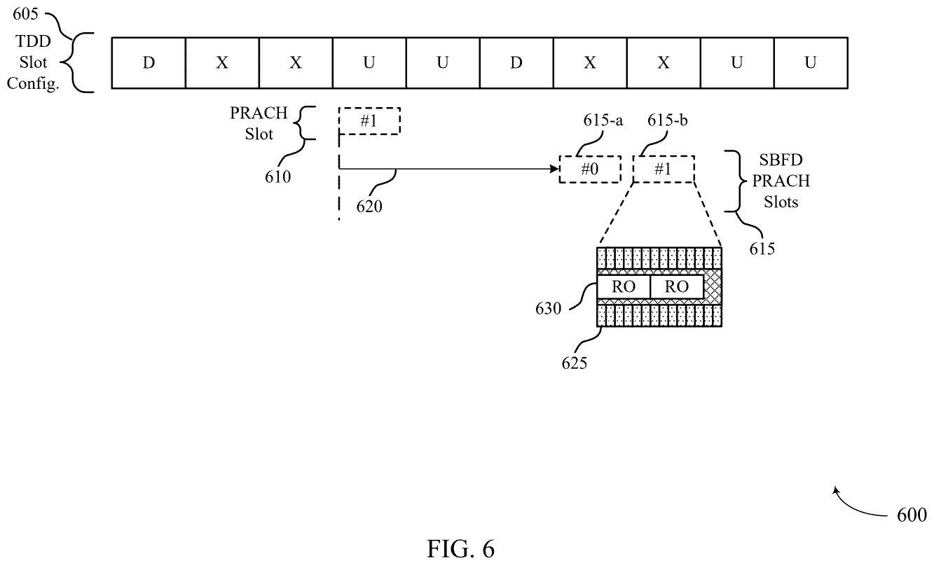

FIG. 6 shows an example of a random access resources 600 that supports random access channel configuration for full duplex communications in accordance with one or more aspects of the present disclosure. In some cases, aspects of the random access resources 600 may implement or be implemented by aspects of a wireless communications system 100 or 200, as described with reference to FIGS. 1 and 2. For example, the random access resources 600 may be configured at network entity 105 and a UE 115, which may be examples of a network entity 105 and UE 115 as described with reference to FIGS. 1 and 2.

In FIG. 6, a TDD slot configuration 605 may include downlink, flexible, and uplink slots, where flexible and/or downlink slots may be configured as SBFD slots. In this example, a PRACH configuration may configure one TDD PRACH slot 610, and SBFD PRACH slots 615 may be determined based on a time offset 620 from the TDD PRACH slot 610. In this example, a two-to-one mapping between the TDD PRACH slot 610 and the SBFD PRACH slots 615 may indicate a first SBFD PRACH slot 615-a and a second SBFD PRACH slot 615-b. Each SBFD PRACH slot 615 may include downlink sub-bands 625 and an uplink sub-band 630 that includes two ROs, although more of fewer ROs may be present.

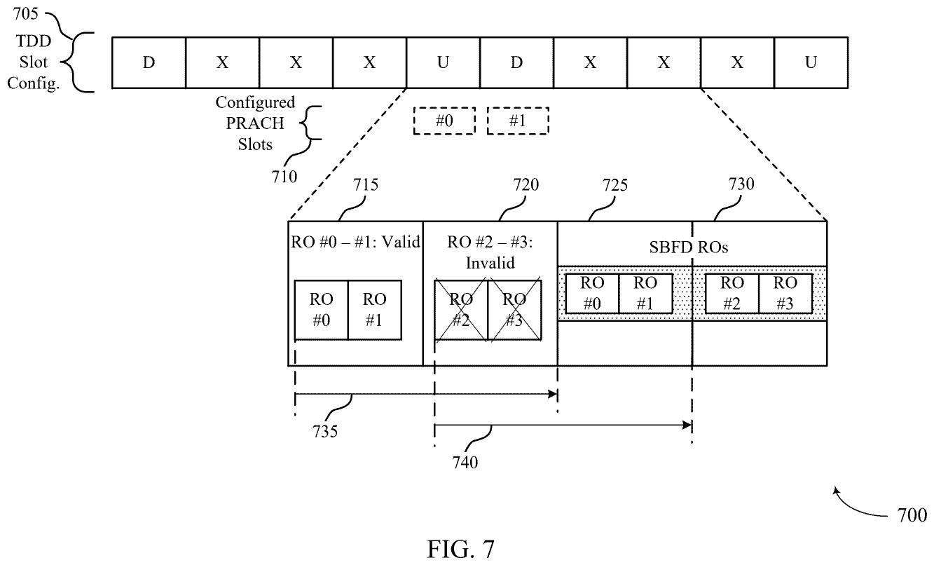

FIG. 7 shows an example of a random access resources 700 that supports random access channel configuration for full duplex communications in accordance with one or more aspects of the present disclosure. In some cases, aspects of the random access resources 700 may implement or be implemented by aspects of a wireless communications system 100 or 200, as described with reference to FIGS. 1 and 2. For example, the random access resources 700 may be configured at network entity 105 and a UE 115, which may be examples of a network entity 105 and UE 115 as described with reference to FIGS. 1 and 2.

In FIG. 7, a TDD slot configuration 705 may include downlink, flexible, and uplink slots, where downlink and/or flexible slots may be configured as SBFD slots, as discussed herein. In this example, a PRACH configuration may configure TDD PRACH slots 710 as containing ROs, including a first PRACH slot 715 and a second PRACH slot 720. In this example, however, the second PRACH slot 720 is configured as a downlink slot. Thus, in this example, ROs in the first PRACH slot 715 (i.e., RO #0 and RO #1) are valid, and ROs in the second PRACH slot 720 (i.e., RO #2 and RO #3) are invalid. In some aspects, SBFD ROs in a first SBFD slot 725 and a second SBFD slot 730 are determined based on the configured TDD ROs, irrespective of whether the associated ROs are valid. Thus, in this example, a first time offset 735 from the first ROs in first PRACH slot 715 may be used to identify ROs in the first SBFD slot 725 (i.e., SBFD ROs #0 and #1), and a second time offset 740 from the ROs in the second PRACH slot 720 may be used to identify ROs in the second SBFD slot 730 (i.e., SBFD ROs #2 and #3).

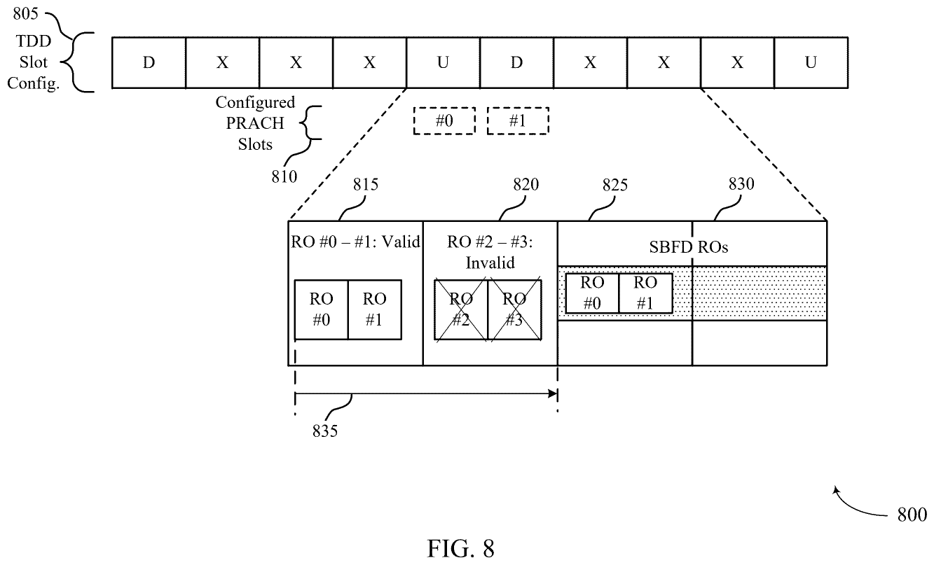

FIG. 8 shows an example of a random access resources 800 that supports random access channel configuration for full duplex communications in accordance with one or more aspects of the present disclosure. In some cases, aspects of the random access resources 800 may implement or be implemented by aspects of a wireless communications system 100 or 200, as described with reference to FIGS. 1 and 2. For example, the random access resources 800 may be configured at network entity 105 and a UE 115, which may be examples of a network entity 105 and UE 115 as described with reference to FIGS. 1 and 2.

In FIG. 8, a TDD slot configuration 805 may include downlink, flexible, and uplink slots, where downlink or flexible slots may be configured as SBFD slots, as discussed herein. In this example, a PRACH configuration may configure TDD PRACH slots 810 as containing ROs, including a first PRACH slot 815 and a second PRACH slot 820. In this example, similarly as discussed with reference to FIG. 7, the second PRACH slot 820 is configured in a downlink slot. Thus, in this example, ROs in the first PRACH slot 815 (i.e., RO #0 and RO #1) are valid, and ROs in the second PRACH slot 820 (i.e., RO #2 and RO #3) are invalid. In some aspects, SBFD ROs in a first SBFD slot 825 and a second SBFD slot 830 are determined based on valid TDD ROs in the PRACH slots 810. Thus, in this example, a time offset 835 from the valid ROs in the first PRACH slot 815 may be used to identify ROs in the first SBFD slot 825 (i.e., SBFD ROs #0 and #1), and the second SBFD slot 830 may not include any ROs due to the invalid ROs in the second PRACH slot 820.

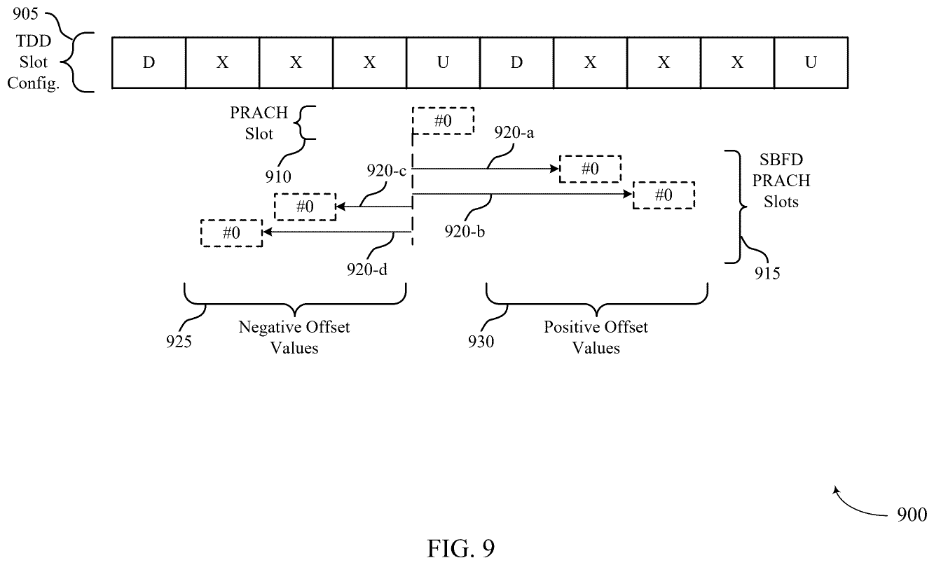

FIG. 9 shows an example of a random access resources 900 that supports random access channel configuration for full duplex communications in accordance with one or more aspects of the present disclosure. In some cases, aspects of the random access resources 900 may implement or be implemented by aspects of a wireless communications system 100 or 200, as described with reference to FIGS. 1 and 2. For example, the random access resources 900 may be configured at network entity 105 and a UE 115, which may be examples of a network entity 105 and UE 115 as described with reference to FIGS. 1 and 2.

In FIG. 9, a TDD slot configuration 905 may include downlink, flexible, and uplink slots, where downlink or flexible slots may be configured as SBFD slots, as discussed herein. In this example, a PRACH configuration may configure a TDD PRACH slot 910 as containing ROs. In this example, ROs of SBFD PRACH slots 915 may be determined based on a time offset 920 from the TDD PRACH slot 910, where the time offset 920 may be positive of negative. For example, positive offset values 930 may be provided by a first time offset 920-a or a second time offset 920-b. Likewise, negative offset values 925 may be provided by a third time offset 920-c or a fourth time offset 920-d.

In some aspects, the time offset 920 may be based on physical slot counting. In other aspects, the time offset 920 may be based on available SBFD PRACH slot 915 counting. For example, first time offset 920-a may have a slot offset value of two slots that use physical slot counting, and second time offset 920-b may have a slot offset value of two slots that use available SBFD PRACH slot counting, and thus these two time offsets 920-a and 920-b result in selection of different SBFD PRACH slots 915. Available SBFD slot counting, in these examples, refers to only counting the SBFD slots from the reference PRACH slot or RO. In some aspects, the time offset 920 may have slot or symbol granularity, where, for slot granularity, TDD-ROs and SBFD-ROs are separated in different slots, and, for symbol granularity, TDD-ROs and SBFD-ROs can be in same or different slots. In some aspects, a value for the time offset 920 may be implicit or explicit. For an implicit value, the time offset 920 may be based on a first available SBFD slot (e.g., slot offset=1). For an explicit value, the time offset 920 may be based on RRC configuration.

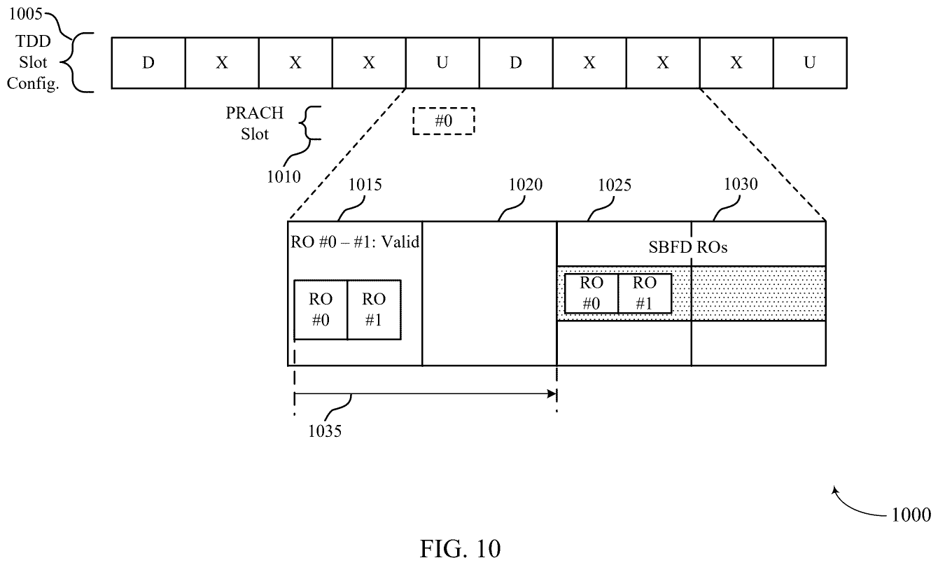

FIG. 10 shows an example of a random access resources 1000 that supports random access channel configuration for full duplex communications in accordance with one or more aspects of the present disclosure. In some cases, aspects of the random access resources 1000 may implement or be implemented by aspects of a wireless communications system 100 or 200, as described with reference to FIGS. 1 and 2. For example, the random access resources 1000 may be configured at network entity 105 and a UE 115, which may be examples of a network entity 105 and UE 115 as described with reference to FIGS. 1 and 2.

In FIG. 10, a TDD slot configuration 1005 may include downlink, flexible, and uplink slots, where flexible slots may be configured as SBFD slots, as discussed herein. In this example, a PRACH configuration may configure a TDD PRACH slot 1010 as containing ROs, including a first PRACH slot 1015. In this example, similarly as discussed with reference to FIGS. 7 and 8, a second PRACH slot 1020 is configured as a downlink slot. Thus, in this example, ROs in the first PRACH slot 1015 (i.e., RO #0 and RO #1) are valid. In some aspects, SBFD ROs in a first SBFD slot 1025 are determined based on valid first ROs in the PRACH slot 1015. Thus, in this example, a time offset 1035 from the first valid RO in the PRACH slot 1015 may be used to identify ROs in the first SBFD slot 1025 (i.e., SBFD ROs #0 and #1) with no ROs in second SBFD slot 1030. In some cases, the time offset 1035 may be based on physical symbol or slot counting, or the time offset 1035 may be based on available SBFD symbol or slot counting. Thus, for slot-based offsets, TDD-RO and SBFD-ROs may be separated in different slots, and for symbol-based offsets, TDD-RO and SBFD-ROs can be in same or different slots.

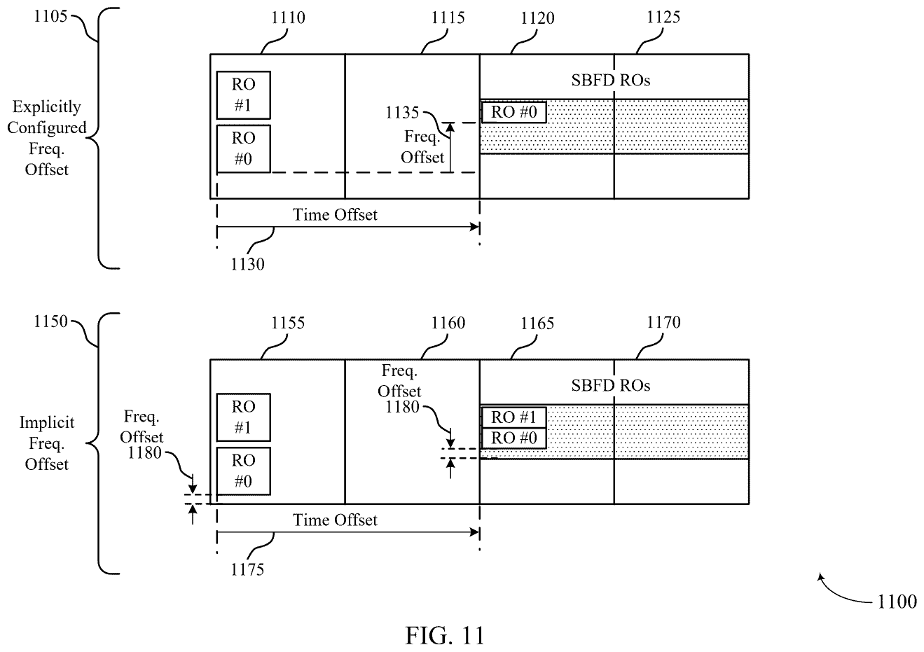

FIG. 11 shows an example of a random access resources 1100 that supports random access channel configuration for full duplex communications in accordance with one or more aspects of the present disclosure. In some cases, aspects of the random access resources 1100 may implement or be implemented by aspects of a wireless communications system 100 or 200, as described with reference to FIGS. 1 and 2. For example, the random access resources 1100 may be configured at network entity 105 and a UE 115, which may be examples of a network entity 105 and UE 115 as described with reference to FIGS. 1 and 2.

In FIG. 11, frequency resources for SBFD ROs may be identified based on a configuration or based on an RO frequency offset provided in a PRACH configuration. In a first example, a first slot 1110 may be a TDD uplink slot, a second slot 1115 may be a downlink slot, and a third slot 1120 and a fourth slot 1125 may be SBFD slots. In some aspects, an explicitly configured frequency offset 1105 may provide that SBFD RO resources may be identified based on a time offset 1130 and a frequency offset 1135 from a TDD RO. In this example, a first TDD slot 1110 may include two TDD ROs that are frequency division multiplexed, and a location of a SBFD RO in third slot 1120 may be determined based on the time offset 1130 and the frequency offset 1135.

In a second example, a first slot 1155 may be a TDD uplink slot, a second slot 1160 may be a downlink slot, and a third slot 1165 and a fourth slot 1170 may be SBFD slots. In some aspects, an implicit frequency offset 1150 may provide that SBFD RO resources may be identified based on a time offset 1175 and a frequency offset 1180 from a TDD RO. In this example, a first TDD slot 1110 may include two TDD ROs that are frequency division multiplexed, and a location of SBFD ROs in third slot 1165 may be determined based on the time offset 1130 and the implicit frequency offset 1180 from a start of an uplink sub-band of the SBFD third slot 1165. In some cases, for an implicit indication, a starting resource block (RB) for a SBFD RO (e.g., a lowest RO in a frequency domain) may be interpreted with respect to a first physical resource block (PRB) (e.g., a lowest PRB in a frequency domain) in the uplink sub-band (or usable PRB in uplink sub-band) and with a modulo operation based on the size of the uplink sub-band or number of PRBs in the uplink sub-band. In cases with an explicit indication of a frequency offset, an RB-offset may be RRC configured. Further, in some aspects, a UE may determine whether ROs are frequency division multiplexed in SBFD slots, and such a determination may be based on a same number of frequency division multiplexed ROs as in TDD PRACH slots, may be based on fewer frequency division multiplexed ROs that in TDD PRACH slots based on a side of the uplink sub-band, or may be determined in accordance with an explicit configuration that may be different than in the PRACH configuration for TDD communications.

Additionally, or alternatively, a PRACH format in SBFD-PRACH ROs may be a same format as the PRACH format of the TDD-PRACH, or may be a different PRACH format than the TDD-PRACH format. The PRACH format may be explicitly configured by RRC or implicitly determined based on a rule or association with the TDD PRACH format. For example, SBFD PRACH format A1/A2 may be associated with long format sequence 0, and SBFD PRACH format B1/B2 may be associated with format sequence 1. In some aspects, a quantity of SBFD-PRACH slots may also be either explicitly configured or implicitly determined (e.g., same as TDD PRACH slot or integer number of slots). In some aspects, a quantity of ROs per SBFD PRACH slot may be based on a PRACH sequence for a random access message. For example, if the same PRACH sequence is used, then a same quantity of ROs may be used, or a subset or even integer multiple of ROs may be used. If a different PRACH sequence is used for SBFD ROs, then a quantity of SBFD ROs may be scaled by a factor that is based on a ratio of sequence length. In some aspects, a length of the SBFD RO in a quantity of symbols may be the same at TDD ROs when a same PRACH sequence is used, and otherwise may be scaled based on a different in the sequence lengths. In some aspects, a time gap between consecutive SBFD ROs and freq. gap between frequency division multiplexed SBFD ROs may be configured, or a default behavior that no gap is present may be used. Additionally, or alternatively, mapping between ROs and synchronization signal blocks (SSBs) may be provided. In some aspects, separate SSB-RO mapping for the additional SBFD-ROs may be provided, in addition to SSB-RO mapping for TDD-ROs. In other aspects, a single SBFD mapping across both TDD-ROs and SBFD-ROs may be used.

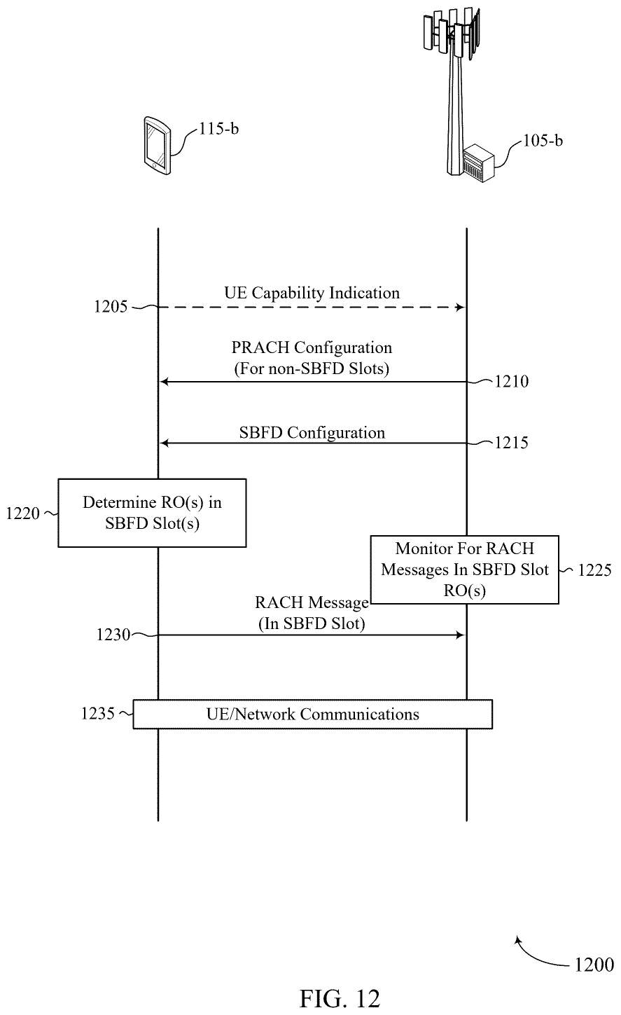

FIG. 12 shows an example of a process flow 1200 that supports random access channel configuration for full duplex communications in accordance with one or more aspects of the present disclosure. In some cases, aspects of the process flow 1200 may implement or be implemented by aspects of a wireless communications system 100 or 200, or random access resource, as described with reference to FIGS. 1 through 11. For example, the process flow 1200 may include a UE 115-b, which may be an example of a UE 115 as described with reference to FIGS. 1 through 11. Additionally, the process flow 1200 may include a network entity 105-b, which may be an example of a network entity 105 as described with reference to FIGS. 1 through 11.

In the following description of the process flow 1200, the operations may be performed in a different order than the order shown. Additionally, or alternatively, other operations may be added or removed from the process flow 1200. Although the UE 115-b, and the network entity 105-b are shown performing the operations of the process flow 1200, some aspects of some operations may be performed by one or more other devices (e.g., other UEs 115, other network entities 105, or other entities external to the network).

At 1205, optionally, the UE 115-b may transmit, and the network entity 105-b may receive, a UE capability indication. In some cases, the UE capability indication may be provided via RRC signaling with other UE 115-b capabilities. In some cases, the UE capability indication may be provided in response to a query from the network entity 105-b. In some cases, the UE capability indication may indicate that the UE 115-b can identify the time resources and the frequency resources for a random access message in a full-duplex slot based at least in part on a random access channel configuration associated with non-full-duplex slots.

At 1210, the network entity 105-b may transmit, and the UE 115-b may receive, a PRACH configuration. In some cases, the PRACH configuration may be provided for non-SBFD slots in a TDD slot configuration. In some cases, the PRACH configuration may indicate a PRACH configuration index value that is mapped to parameters that define locations of ROs.

At 1215, the network entity 105-b may transmit, and the UE 115-b may receive, SBFD configuration. In some cases, the SBFD configuration may indicate that one or more TDD slots in a TDD configuration are SBFD slots in which the network entity 105-b may transmit downlink communications to a UE using one or more downlink sub-bands while receiving uplink communications from a same or different UE using an uplink sub-band.

At 1220, the UE 115-b may determine resources for one or more ROs in one or more SBFD slots based on the PRACH configuration and the SBFD configuration. The UE 115-b may determine the RO location(s) in the SBFD slots in accordance with various techniques as discussed herein, including determination of time resources and frequency resources for one or more ROs. At 1225, the network entity 105-b may monitor for RACH messages in one or more SBFD slot ROs.

At 1230, the UE 115-b may transmit, and the network entity 105-b may receive, a RACH message (e.g., MSG1) in an RO of a SBFD slot. At 1235, the UE 115-b and network entity 105-b may communicate using established communications procedures that are triggered by the RACH message.

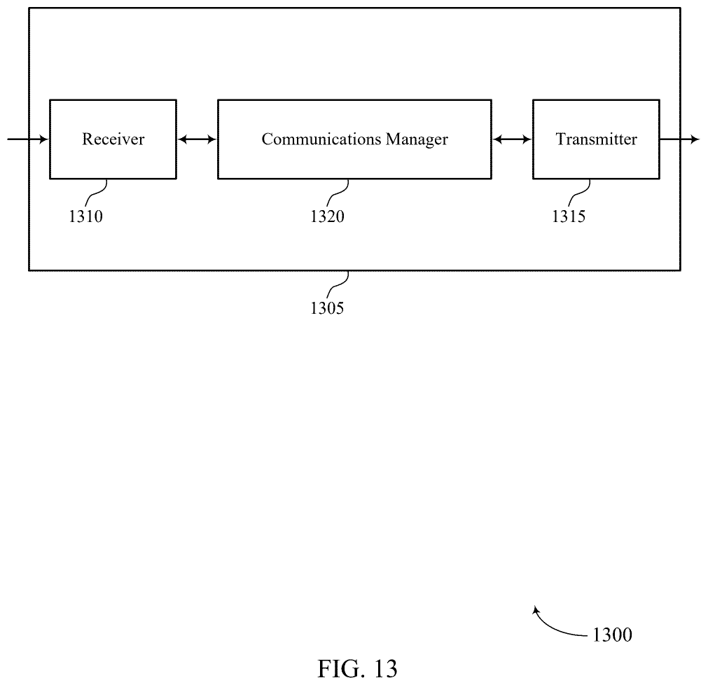

FIG. 13 shows a block diagram 1300 of a device 1305 that supports random access channel configuration for full duplex communications in accordance with one or more aspects of the present disclosure. The device 1305 may be an example of aspects of a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to random access channel configuration for full duplex communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to random access channel configuration for full duplex communications). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations or components thereof may be examples of means for performing various aspects of random access channel configuration for full duplex communications as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. For example, the communications manager 1320 is capable of, configured to, or operable to support a means for receiving a first signal that indicates a random access channel configuration associated with a set of non-full-duplex slots, the random access channel configuration indicating a first subset of non-full-duplex slots of the set of non-full-duplex slots that include resources for one or more random access occasions. The communications manager 1320 is capable of, configured to, or operable to support a means for receiving a second signal that indicates a full-duplex configuration that indicates a set of full-duplex slots, where slots of the set of full-duplex slots are non-overlapping with slots of the set of non-full-duplex slots. The communications manager 1320 is capable of, configured to, or operable to support a means for transmitting a random access message in at least a first full-duplex slot of the set of full-duplex slots, where time resources and frequency resources for the random access message in the first full-duplex slot are identified based on the random access channel configuration associated with the set of non-full-duplex slots.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for providing ROs in full-duplex slots that are in addition to ROs provided in non-dull-duplex slots, which may provide for reduced latency, enhanced throughput, more efficient utilization of communication resources, improved communication reliability, and improved user experience.

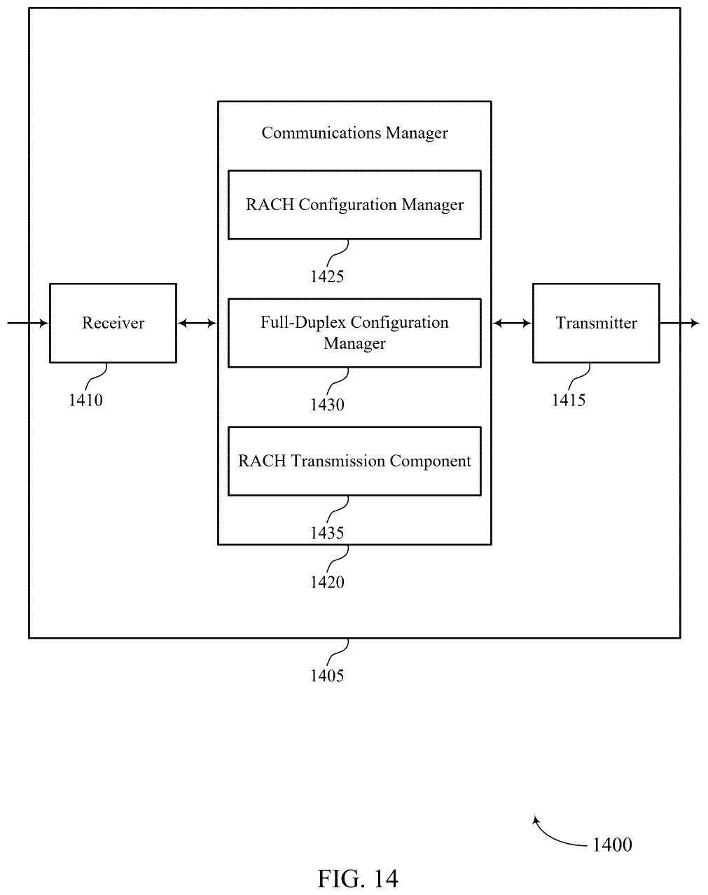

FIG. 14 shows a block diagram 1400 of a device 1405 that supports random access channel configuration for full duplex communications in accordance with one or more aspects of the present disclosure. The device 1405 may be an example of aspects of a device 1305 or a UE 115 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to random access channel configuration for full duplex communications). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to random access channel configuration for full duplex communications). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of random access channel configuration for full duplex communications as described herein. For example, the communications manager 1420 may include a RACH configuration manager 1425, a full-duplex configuration manager 1430, a RACH transmission component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. The RACH configuration manager 1425 is capable of, configured to, or operable to support a means for receiving a first signal that indicates a random access channel configuration associated with a set of non-full-duplex slots, the random access channel configuration indicating a first subset of non-full-duplex slots of the set of non-full-duplex slots that include resources for one or more random access occasions. The full-duplex configuration manager 1430 is capable of, configured to, or operable to support a means for receiving a second signal that indicates a full-duplex configuration that indicates a set of full-duplex slots, where slots of the set of full-duplex slots are non-overlapping with slots of the set of non-full-duplex slots. The RACH transmission component 1435 is capable of, configured to, or operable to support a means for transmitting a random access message in at least a first full-duplex slot of the set of full-duplex slots, where time resources and frequency resources for the random access message in the first full-duplex slot are identified based on the random access channel configuration associated with the set of non-full-duplex slots.

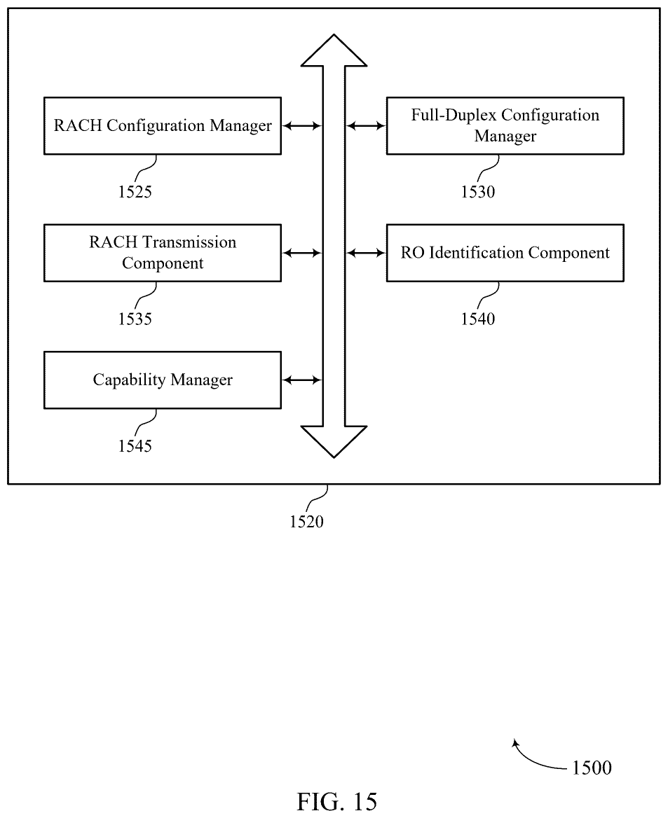

FIG. 15 shows a block diagram 1500 of a communications manager 1520 that supports random access channel configuration for full duplex communications in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of random access channel configuration for full duplex communications as described herein. For example, the communications manager 1520 may include a RACH configuration manager 1525, a full-duplex configuration manager 1530, a RACH transmission component 1535, an RO identification component 1540, a capability manager 1545, or any combination thereof. Each of these components, or components or subcomponents thereof (e.g., one or more processors, one or more memories), may communicate, directly or indirectly, with one another (e.g., via one or more buses).

The communications manager 1520 may support wireless communication in accordance with examples as disclosed herein. The RACH configuration manager 1525 is capable of, configured to, or operable to support a means for receiving a first signal that indicates a random access channel configuration associated with a set of non-full-duplex slots, the random access channel configuration indicating a first subset of non-full-duplex slots of the set of non-full-duplex slots that include resources for one or more random access occasions. The full-duplex configuration manager 1530 is capable of, configured to, or operable to support a means for receiving a second signal that indicates a full-duplex configuration that indicates a set of full-duplex slots, where slots of the set of full-duplex slots are non-overlapping with slots of the set of non-full-duplex slots. The RACH transmission component 1535 is capable of, configured to, or operable to support a means for transmitting a random access message in at least a first full-duplex slot of the set of full-duplex slots, where time resources and frequency resources for the random access message in the first full-duplex slot are identified based on the random access channel configuration associated with the set of non-full-duplex slots.

In some examples, the RO identification component 1540 is capable of, configured to, or operable to support a means for identifying, based on a time offset from one or more slots of the first subset of non-full-duplex slots, a second subset of full-duplex slots within the set of full-duplex slots that include one or more random access occasions that are available for transmission of the random access message.

In some examples, the second subset of full-duplex slots are identified based on a mapping from the first subset of non-full-duplex slots, and where the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots.

In some examples, the RACH configuration manager 1525 is capable of, configured to, or operable to support a means for determining a location of the first full-duplex slot based on a time offset from a non-full-duplex slot of the first subset of non-full-duplex slots, and where the time offset includes the non-full-duplex slot or starts from a subsequent slot to the second non-full-duplex slot. In some examples, the set of full-duplex slots includes at least two full-duplex slots that are mapped to a first non-full-duplex slot of the first subset of non-full-duplex slots.

In some examples, the RACH configuration manager 1525 is capable of, configured to, or operable to support a means for determining a location of the first full-duplex slot based on a time offset from a non-full-duplex slot of the first subset of non-full-duplex slots, and where the time offset indicates a quantity of physical slots relative to the non-full-duplex slot or a quantity of available full-duplex slots relative to the second non-full-duplex slot. In some examples, the time offset indicates a positive or negative quantity of slots relative to the second non-full-duplex slot.

In some examples, the RO identification component 1540 is capable of, configured to, or operable to support a means for identifying one or more random access occasions in the first full-duplex slot based on a time offset from a random access channel occasion in a first non-full-duplex slot of the first subset of non-full-duplex slots, where the first full-duplex slot includes the one or more random access occasions irrespective of whether the first non-full-duplex slot is a valid uplink slot.

In some examples, the RO identification component 1540 is capable of, configured to, or operable to support a means for determining a location of the one or more random access occasions in the first full-duplex slot based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots.

In some examples, the RO identification component 1540 is capable of, configured to, or operable to support a means for identifying one or more random access occasions for a random access channel transmission in the first full-duplex slot based on a time offset only from a valid random access occasion in the first subset of non-full-duplex slots.

In some examples, the RO identification component 1540 is capable of, configured to, or operable to support a means for determining a location of the one or more random access occasions in the first full-duplex slot based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots.

In some examples, the RACH configuration manager 1525 is capable of, configured to, or operable to support a means for determining a location of the first full-duplex slot based on a time offset from a non-full-duplex slot of the first subset of non-full-duplex slots, and where the time offset is a defined offset value or is provided to the UE in the random access channel configuration.

In some examples, the RACH configuration manager 1525 is capable of, configured to, or operable to support a means for determining a location of the frequency resources for the random access message in the first full-duplex slot based on a frequency offset associated with an uplink sub-band of the first full-duplex slot, and where the frequency offset corresponds to a first physical resource block of the uplink sub-band of the first full-duplex slot, or the frequency offset is provided to the UE in the random access channel configuration.

In some examples, the first full-duplex slot includes an uplink sub-band that includes frequency resources for at least two random access occasions, the random access message transmitted using frequency resources of one of the at least two random access occasions. In some examples, the at least two random access occasions are frequency division multiplexed within the uplink sub-band in accordance with a frequency division multiplexing configuration provided with the random access channel configuration associated with a set of non-full-duplex slots. In some examples, the at least two random access occasions are frequency division multiplexed within the uplink sub-band based on a bandwidth of the uplink sub-band. In some examples, the at least two random access occasions are frequency division multiplexed within the uplink sub-band in accordance with a frequency division multiplexing configuration provided with the full-duplex configuration.

In some examples, the RACH transmission component 1535 is capable of, configured to, or operable to support a means for formatting a sequence of the random access message in accordance with a same format indicated in the random access channel configuration, or in accordance with a format indicated in the full-duplex configuration. In some examples, a quantity of full-duplex slots of the set of full-duplex slots that are configured for transmission of the random access message is signaled to the UE, or is determined based on a quantity of non-full-duplex slots that are configured for transmission of random access messages.

In some examples, a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots. In some examples, a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

In some examples, a time duration of one or more random access occasions within the first full-duplex slot is a same duration as, or a different duration than, a time duration of the one or more random access occasions of the first subset of non-full-duplex slots, based on whether a same or different random access channel sequence is configured for full-duplex slots and non-full-duplex slots. In some examples, the first full-duplex slot includes time resources for two or more random access occasions and frequency resources for the two or more random access occasions, and where a time gap and a frequency gap between consecutive random access occasions are each zero unless configured to a non-zero value.

In some examples, the RO identification component 1540 is capable of, configured to, or operable to support a means for receiving mapping information that indicates a correspondence between one or more random access occasions within the first full-duplex slot and one or more synchronization signal blocks, and where the mapping information is provided separately from other mapping information associated with non-full-duplex slots. In some examples, the RACH configuration manager 1525 is capable of, configured to, or operable to support a means for receiving mapping information that indicates a correspondence between one or more random access occasions and one or more synchronization signal blocks, and where the mapping information applies to both full-duplex slots and non-full-duplex slots.

In some examples, the capability manager 1545 is capable of, configured to, or operable to support a means for transmitting a UE capability indication that the UE can identify the time resources and the frequency resources for the random access message in the first full-duplex slot based on the random access channel configuration associated with the set of non-full-duplex slots.

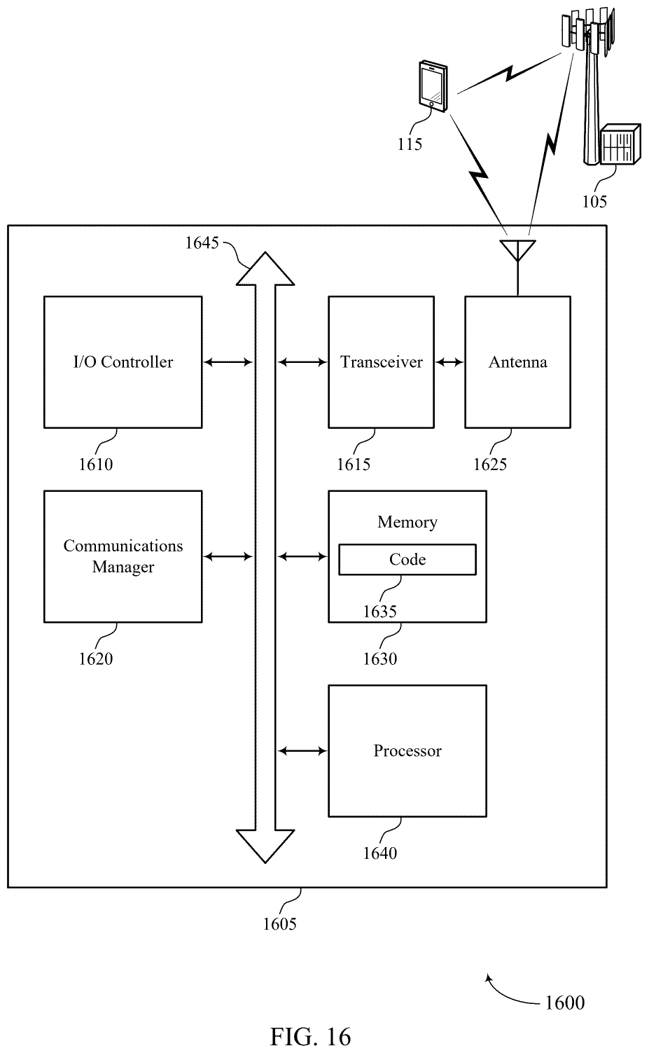

FIG. 16 shows a diagram of a system 1600 including a device 1605 that supports random access channel configuration for full duplex communications in accordance with one or more aspects of the present disclosure. The device 1605 may be an example of or include components of a device 1305, a device 1405, or a UE 115 as described herein. The device 1605 may communicate (e.g., wirelessly) with one or more other devices (e.g., network entities 105, UEs 115, or a combination thereof). The device 1605 may include components for bi-directional voice and data communications including components for transmitting and receiving communications, such as a communications manager 1620, an input/output (I/O) controller, such as an I/O controller 1610, a transceiver 1615, one or more antennas 1625, at least one memory 1630, code 1635, and at least one processor 1640. These components may be in electronic communication or otherwise coupled (e.g., operatively, communicatively, functionally, electronically, electrically) via one or more buses (e.g., a bus 1645).

The I/O controller 1610 may manage input and output signals for the device 1605. The I/O controller 1610 may also manage peripherals not integrated into the device 1605. In some cases, the I/O controller 1610 may represent a physical connection or port to an external peripheral. In some cases, the I/O controller 1610 may utilize an operating system such as iOS®, ANDROID®, MS-DOS®, MS-WINDOWS®, OS/2®, UNIX®, LINUX®, or another known operating system. Additionally, or alternatively, the I/O controller 1610 may represent or interact with a modem, a keyboard, a mouse, a touchscreen, or a similar device. In some cases, the I/O controller 1610 may be implemented as part of one or more processors, such as the at least one processor 1640. In some cases, a user may interact with the device 1605 via the I/O controller 1610 or via hardware components controlled by the I/O controller 1610.

In some cases, the device 1605 may include a single antenna. However, in some other cases, the device 1605 may have more than one antenna, which may be capable of concurrently transmitting or receiving multiple wireless transmissions. The transceiver 1615 may communicate bi-directionally via the one or more antennas 1625 using wired or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The at least one memory 1630 may include random access memory (RAM) and read-only memory (ROM). The at least one memory 1630 may store computer-readable, computer-executable, or processor-executable code, such as the code 1635. The code 1635 may include instructions that, when executed by the at least one processor 1640, cause the device 1605 to perform various functions described herein. The code 1635 may be stored in a non-transitory computer-readable medium such as system memory or another type of memory. In some cases, the code 1635 may not be directly executable by the at least one processor 1640 but may cause a computer (e.g., when compiled and executed) to perform functions described herein. In some cases, the at least one memory 1630 may include, among other things, a basic I/O system (BIOS) which may control basic hardware or software operation such as the interaction with peripheral components or devices.

The at least one processor 1640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1640 may be configured to operate a memory array using a memory controller. In some other cases, a memory controller may be integrated into the at least one processor 1640. The at least one processor 1640 may be configured to execute computer-readable instructions stored in a memory (e.g., the at least one memory 1630) to cause the device 1605 to perform various functions (e.g., functions or tasks supporting random access channel configuration for full duplex communications). For example, the device 1605 or a component of the device 1605 may include at least one processor 1640 and at least one memory 1630 coupled with or to the at least one processor 1640, the at least one processor 1640 and the at least one memory 1630 configured to perform various functions described herein.

In some examples, the at least one processor 1640 may include multiple processors and the at least one memory 1630 may include multiple memories. One or more of the multiple processors may be coupled with one or more of the multiple memories, which may, individually or collectively, be configured to perform various functions described herein. In some examples, the at least one processor 1640 may be a component of a processing system, which may refer to a system (such as a series) of machines, circuitry (including, for example, one or both of processor circuitry (which may include the at least one processor 1640) and memory circuitry (which may include the at least one memory 1630)), or components, that receives or obtains inputs and processes the inputs to produce, generate, or obtain a set of outputs. The processing system may be configured to perform one or more of the functions described herein. For example, the at least one processor 1640 or a processing system including the at least one processor 1640 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code 1635 (e.g., processor-executable code) stored in the at least one memory 1630 or otherwise, to perform one or more of the functions described herein.

The communications manager 1620 may support wireless communication in accordance with examples as disclosed herein. For example, the communications manager 1620 is capable of, configured to, or operable to support a means for receiving a first signal that indicates a random access channel configuration associated with a set of non-full-duplex slots, the random access channel configuration indicating a first subset of non-full-duplex slots of the set of non-full-duplex slots that include resources for one or more random access occasions. The communications manager 1620 is capable of, configured to, or operable to support a means for receiving a second signal that indicates a full-duplex configuration that indicates a set of full-duplex slots, where slots of the set of full-duplex slots are non-overlapping with slots of the set of non-full-duplex slots. The communications manager 1620 is capable of, configured to, or operable to support a means for transmitting a random access message in at least a first full-duplex slot of the set of full-duplex slots, where time resources and frequency resources for the random access message in the first full-duplex slot are identified based on the random access channel configuration associated with the set of non-full-duplex slots.

By including or configuring the communications manager 1620 in accordance with examples as described herein, the device 1605 may support techniques for providing ROs in full-duplex slots that are in addition to ROs provided in non-dull-duplex slots, which may provide for reduced latency, enhanced throughput, more efficient utilization of communication resources, improved communication reliability, and improved user experience.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the at least one processor 1640, the at least one memory 1630, the code 1635, or any combination thereof. For example, the code 1635 may include instructions executable by the at least one processor 1640 to cause the device 1605 to perform various aspects of random access channel configuration for full duplex communications as described herein, or the at least one processor 1640 and the at least one memory 1630 may be otherwise configured to, individually or collectively, perform or support such operations.

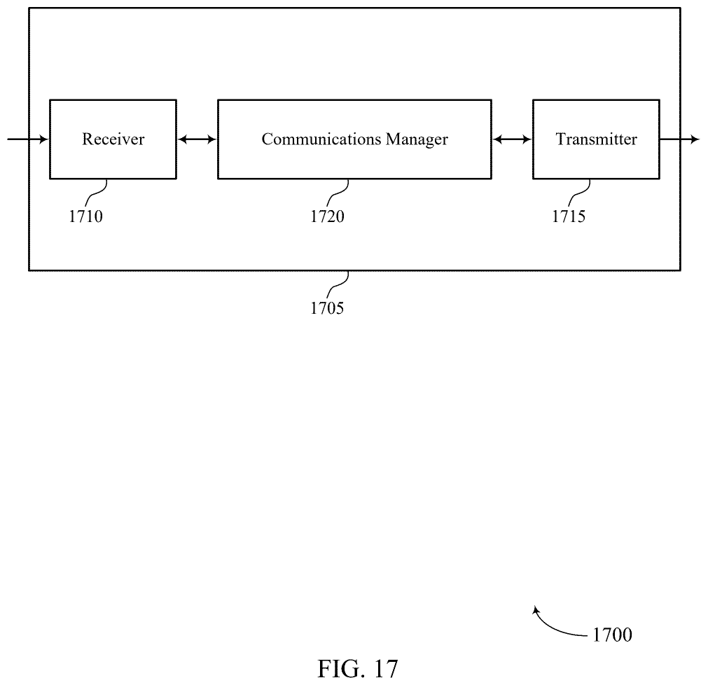

FIG. 17 shows a block diagram 1700 of a device 1705 that supports random access channel configuration for full duplex communications in accordance with one or more aspects of the present disclosure. The device 1705 may be an example of aspects of a network entity 105 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to, individually or collectively, support or enable the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The communications manager 1720, the receiver 1710, the transmitter 1715, or various combinations or components thereof may be examples of means for performing various aspects of random access channel configuration for full duplex communications as described herein. For example, the communications manager 1720, the receiver 1710, the transmitter 1715, or various combinations or components thereof may be capable of performing one or more of the functions described herein.

In some examples, the communications manager 1720, the receiver 1710, the transmitter 1715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1720, the receiver 1710, the transmitter 1715, or various combinations or components thereof may be implemented in code (e.g., as communications management software or firmware) executed by at least one processor (e.g., referred to as a processor-executable code). If implemented in code executed by at least one processor, the functions of the communications manager 1720, the receiver 1710, the transmitter 1715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1720 may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communication in accordance with examples as disclosed herein. For example, the communications manager 1720 is capable of, configured to, or operable to support a means for outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions. The communications manager 1720 is capable of, configured to, or operable to support a means for outputting, to the UE, a second signal that indicates a full-duplex configuration that indicates a set of full-duplex slots, where slots of the set of full-duplex slots are non-overlapping with slots of the set of non-full-duplex slots. The communications manager 1720 is capable of, configured to, or operable to support a means for obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

By including or configuring the communications manager 1720 in accordance with examples as described herein, the device 1705 (e.g., at least one processor controlling or otherwise coupled with the receiver 1710, the transmitter 1715, the communications manager 1720, or a combination thereof) may support techniques for providing ROs in full-duplex slots that are in addition to ROs provided in non-dull-duplex slots, which may provide for reduced latency, enhanced throughput, more efficient utilization of communication resources, improved communication reliability, and improved user experience.

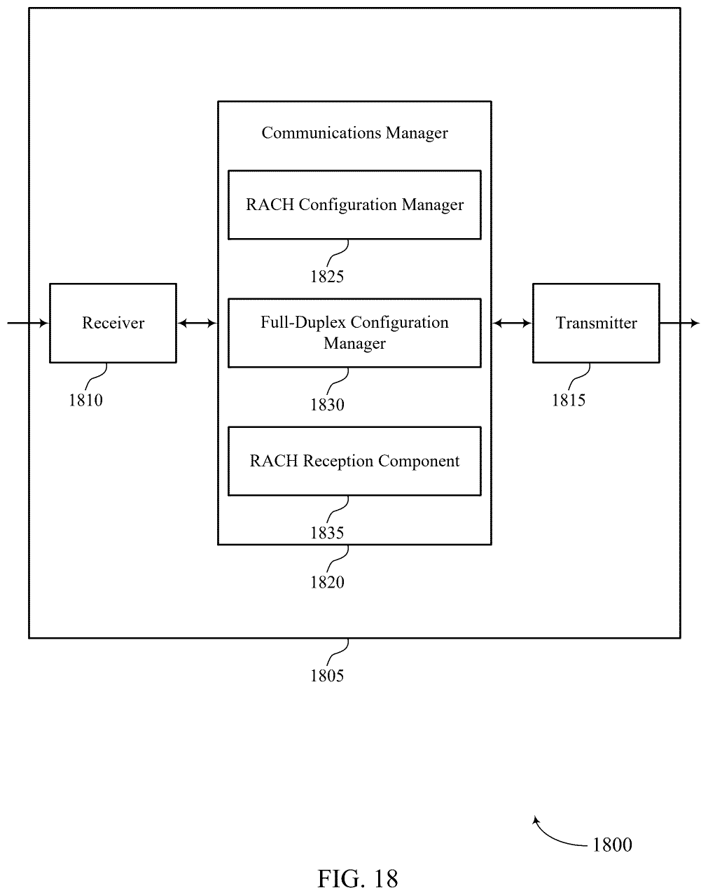

FIG. 18 shows a block diagram 1800 of a device 1805 that supports random access channel configuration for full duplex communications in accordance with one or more aspects of the present disclosure. The device 1805 may be an example of aspects of a device 1705 or a network entity 105 as described herein. The device 1805 may include a receiver 1810, a transmitter 1815, and a communications manager 1820. The device 1805, or one or more components of the device 1805 (e.g., the receiver 1810, the transmitter 1815, the communications manager 1820), may include at least one processor, which may be coupled with at least one memory, to support the described techniques. Each of these components may be in communication with one another (e.g., via one or more buses).

The receiver 1810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1805. In some examples, the receiver 1810 may support obtaining information by receiving signals via one or more antennas. Additionally, or alternatively, the receiver 1810 may support obtaining information by receiving signals via one or more wired (e.g., electrical, fiber optic) interfaces, wireless interfaces, or any combination thereof.

The transmitter 1815 may provide a means for outputting (e.g., transmitting, providing, conveying, sending) information generated by other components of the device 1805. For example, the transmitter 1815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1815 may support outputting information by transmitting signals via one or more antennas. Additionally, or alternatively, the transmitter 1815 may support outputting information by transmitting signals via one or more wired (e.g., electrical, fiber optic) interfaces, wireless interfaces, or any combination thereof. In some examples, the transmitter 1815 and the receiver 1810 may be co-located in a transceiver, which may include or be coupled with a modem.

The device 1805, or various components thereof, may be an example of means for performing various aspects of random access channel configuration for full duplex communications as described herein. For example, the communications manager 1820 may include a RACH configuration manager 1825, a full-duplex configuration manager 1830, a RACH reception component 1835, or any combination thereof. The communications manager 1820 may be an example of aspects of a communications manager 1720 as described herein. In some examples, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The communications manager 1820 may support wireless communication in accordance with examples as disclosed herein. The RACH configuration manager 1825 is capable of, configured to, or operable to support a means for outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions. The full-duplex configuration manager 1830 is capable of, configured to, or operable to support a means for outputting, to the UE, a second signal that indicates a full-duplex configuration that indicates a set of full-duplex slots, where slots of the set of full-duplex slots are non-overlapping with slots of the set of non-full-duplex slots. The RACH reception component 1835 is capable of, configured to, or operable to support a means for obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

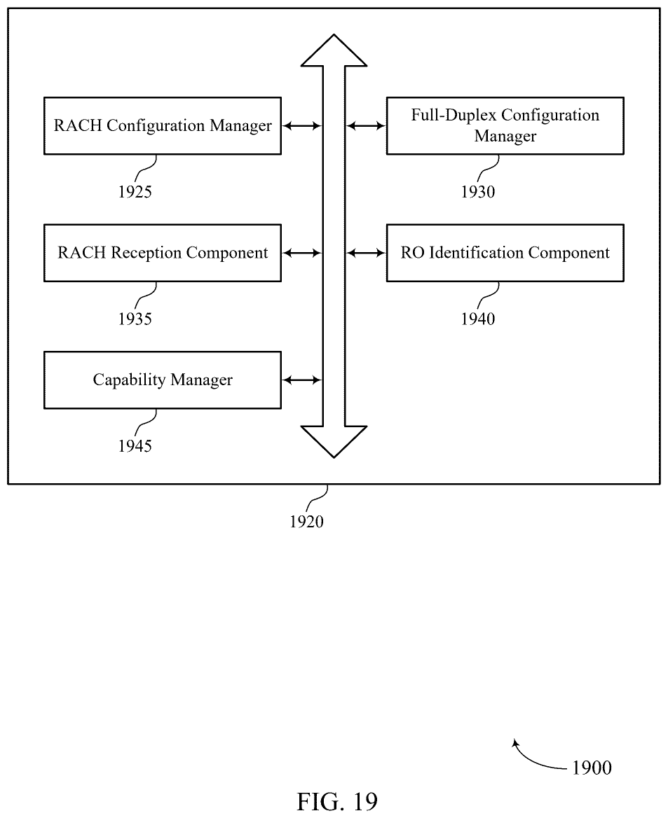

FIG. 19 shows a block diagram 1900 of a communications manager 1920 that supports random access channel configuration for full duplex communications in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of random access channel configuration for full duplex communications as described herein. For example, the communications manager 1920 may include a RACH configuration manager 1925, a full-duplex configuration manager 1930, a RACH reception component 1935, an RO identification component 1940, a capability manager 1945, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1920 may support wireless communication in accordance with examples as disclosed herein. The RACH configuration manager 1925 is capable of, configured to, or operable to support a means for outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions. The full-duplex configuration manager 1930 is capable of, configured to, or operable to support a means for outputting, to the UE, a second signal that indicates a full-duplex configuration that indicates a set of full-duplex slots, where slots of the set of full-duplex slots are non-overlapping with slots of the set of non-full-duplex slots. The RACH reception component 1935 is capable of, configured to, or operable to support a means for obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

In some examples, a second subset of full-duplex slots within the set of full-duplex slots include one or more random access occasions that are available for transmission of the random access message, and where the second subset of full-duplex slots are determined based on a time offset from one or more slots of the first subset of non-full-duplex slots.

In some examples, the second subset of full-duplex slots are identified based on a mapping from the first subset of non-full-duplex slots, and where the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots. In some examples, a location of the first full-duplex slot is determined based on a time offset from a non-full-duplex slot of the first subset of non-full-duplex slots, and where the time offset includes the non-full-duplex slot or starts from a subsequent slot to the second non-full-duplex slot. In some examples, the set of full-duplex slots includes at least two full-duplex slots that are mapped to a first non-full-duplex slot of the first subset of non-full-duplex slots.

In some examples, a location of the first full-duplex slot is determined based on a time offset from a non-full-duplex slot of the first subset of non-full-duplex slots, and where the time offset indicates a quantity of physical slots relative to the non-full-duplex slot or a quantity of available full-duplex slots relative to the second non-full-duplex slot. In some examples, the time offset indicates a positive or negative quantity of slots relative to the second non-full-duplex slot. In some examples, the first full-duplex slot includes one or more random access occasions that are determined based on a time offset from a random access channel occasion in a first non-full-duplex slot of the first subset of non-full-duplex slots, where the first full-duplex slot includes the one or more random access occasions irrespective of whether the first non-full-duplex slot is a valid uplink slot.

In some examples, the first full-duplex slot includes one or more random access occasions for a random access channel transmission that is based on a time offset only from a valid random access occasion in the first subset of non-full-duplex slots. In some examples, a location of the one or more random access occasions in the first full-duplex slot is based on a time offset from one or more random access occasions in the first subset of non-full-duplex slots, and where the time offset indicates a quantity of slots or symbols relative to the one or more random access occasions in one or more non-full-duplex symbols in the first subset of non-full-duplex slots. In some examples, a location of the first full-duplex slot is determined based on a time offset from a non-full-duplex slot of the first subset of non-full-duplex slots, and where the time offset is a defined offset value or is provided to the UE in the random access channel configuration. In some examples, a location of the frequency resources for the random access message in the first full-duplex slot is determined based on a frequency offset associated with an uplink sub-band of the first full-duplex slot, and where the frequency offset corresponds to a first physical resource block of the uplink sub-band of the first full-duplex slot, or the frequency offset is provided to the UE in the random access channel configuration.

In some examples, the first full-duplex slot includes an uplink sub-band that includes frequency resources for at least two random access occasions, the random access message transmitted using frequency resources of one of the at least two random access occasions. In some examples, the at least two random access occasions are frequency division multiplexed within the uplink sub-band in accordance with a frequency division multiplexing configuration provided with the random access channel configuration associated with a set of non-full-duplex slots. In some examples, the at least two random access occasions are frequency division multiplexed within the uplink sub-band based on a bandwidth of the uplink sub-band. In some examples, the at least two random access occasions are frequency division multiplexed within the uplink sub-band in accordance with a frequency division multiplexing configuration provided with the full-duplex configuration.

In some examples, a sequence of the random access message is formatted in accordance with a same format indicated in the random access channel configuration, or in accordance with a format indicated in the full-duplex configuration. In some examples, a quantity of full-duplex slots of the set of full-duplex slots that are configured for transmission of the random access message is signaled to the UE, or is determined based on a quantity of non-full-duplex slots that are configured for transmission of random access messages.

In some examples, a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots. In some examples, a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

In some examples, a time duration of one or more random access occasions within the first full-duplex slot is a same duration as, or a different duration than, a time duration of the one or more random access occasions of the first subset of non-full-duplex slots, based on whether a same or different random access channel sequence is configured for full-duplex slots and non-full-duplex slots. In some examples, the first full-duplex slot includes time resources for two or more random access occasions and frequency resources for the two or more random access occasions, and where a time gap and a frequency gap between consecutive random access occasions are each zero unless configured to a non-zero value.

In some examples, the RACH configuration manager 1925 is capable of, configured to, or operable to support a means for outputting mapping information that indicates a correspondence between one or more random access occasions within the first full-duplex slot and one or more synchronization signal blocks, and where the mapping information is provided separately from other mapping information associated with non-full-duplex slots. In some examples, the capability manager 1945 is capable of, configured to, or operable to support a means for outputting mapping information that indicates a correspondence between one or more random access occasions and one or more synchronization signal blocks, and where the mapping information applies to both full-duplex slots and non-full-duplex slots.

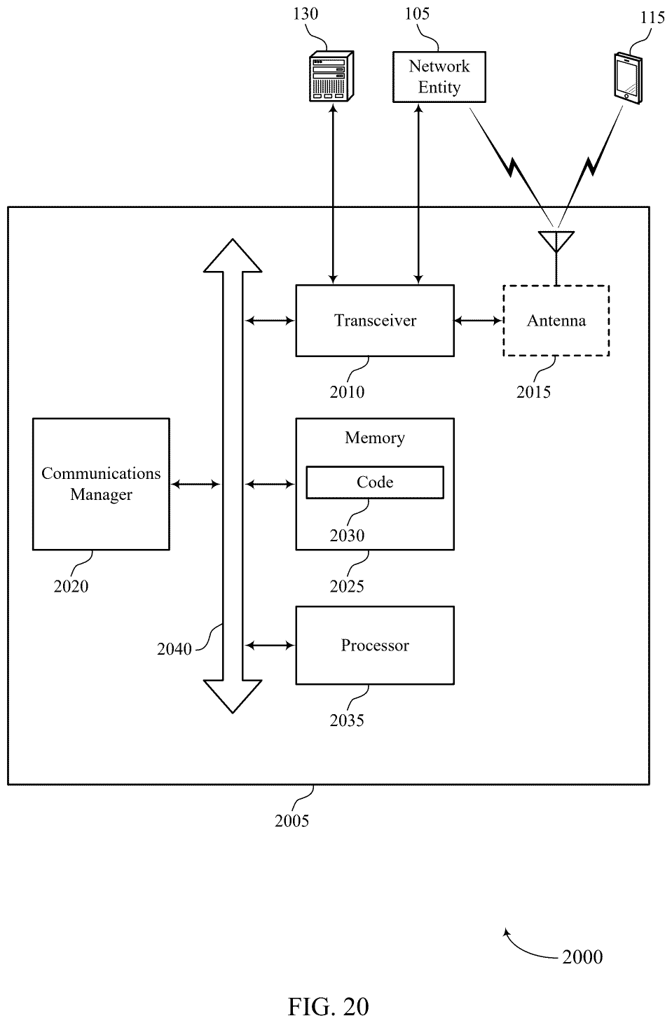

FIG. 20 shows a diagram of a system 2000 including a device 2005 that supports random access channel configuration for full duplex communications in accordance with one or more aspects of the present disclosure. The device 2005 may be an example of or include components of a device 1705, a device 1805, or a network entity 105 as described herein. The device 2005 may communicate with other network devices or network equipment such as one or more of the network entities 105, UEs 115, or any combination thereof. The communications may include communications over one or more wired interfaces, over one or more wireless interfaces, or any combination thereof. The device 2005 may include components that support outputting and obtaining communications, such as a communications manager 2020, a transceiver 2010, one or more antennas 2015, at least one memory 2025, code 2030, and at least one processor 2035. These components may be in electronic communication or otherwise coupled (e.g., operatively, communicatively, functionally, electronically, electrically) via one or more buses (e.g., a bus 2040).

The transceiver 2010 may support bi-directional communications via wired links, wireless links, or both as described herein. In some examples, the transceiver 2010 may include a wired transceiver and may communicate bi-directionally with another wired transceiver. Additionally, or alternatively, in some examples, the transceiver 2010 may include a wireless transceiver and may communicate bi-directionally with another wireless transceiver. In some examples, the device 2005 may include one or more antennas 2015, which may be capable of transmitting or receiving wireless transmissions (e.g., concurrently). The transceiver 2010 may also include a modem to modulate signals, to provide the modulated signals for transmission (e.g., by one or more antennas 2015, by a wired transmitter), to receive modulated signals (e.g., from one or more antennas 2015, from a wired receiver), and to demodulate signals. In some implementations, the transceiver 2010 may include one or more interfaces, such as one or more interfaces coupled with the one or more antennas 2015 that are configured to support various receiving or obtaining operations, or one or more interfaces coupled with the one or more antennas 2015 that are configured to support various transmitting or outputting operations, or a combination thereof. In some implementations, the transceiver 2010 may include or be configured for coupling with one or more processors or one or more memory components that are operable to perform or support operations based on received or obtained information or signals, or to generate information or other signals for transmission or other outputting, or any combination thereof. In some implementations, the transceiver 2010, or the transceiver 2010 and the one or more antennas 2015, or the transceiver 2010 and the one or more antennas 2015 and one or more processors or one or more memory components (e.g., the at least one processor 2035, the at least one memory 2025, or both), may be included in a chip or chip assembly that is installed in the device 2005. In some examples, the transceiver 2010 may be operable to support communications via one or more communications links (e.g., communication link(s) 125, backhaul communication link(s) 120, a midhaul communication link 162, a fronthaul communication link 168).

The at least one memory 2025 may include RAM, ROM, or any combination thereof. The at least one memory 2025 may store computer-readable, computer-executable, or processor-executable code, such as the code 2030. The code 2030 may include instructions that, when executed by one or more of the at least one processor 2035, cause the device 2005 to perform various functions described herein. The code 2030 may be stored in a non-transitory computer-readable medium such as system memory or another type of memory. In some cases, the code 2030 may not be directly executable by a processor of the at least one processor 2035 but may cause a computer (e.g., when compiled and executed) to perform functions described herein. In some cases, the at least one memory 2025 may include, among other things, a BIOS which may control basic hardware or software operation such as the interaction with peripheral components or devices. In some examples, the at least one processor 2035 may include multiple processors and the at least one memory 2025 may include multiple memories. One or more of the multiple processors may be coupled with one or more of the multiple memories which may, individually or collectively, be configured to perform various functions herein (for example, as part of a processing system).

The at least one processor 2035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2035 may be configured to operate a memory array using a memory controller. In some other cases, a memory controller may be integrated into one or more of the at least one processor 2035. The at least one processor 2035 may be configured to execute computer-readable instructions stored in a memory (e.g., one or more of the at least one memory 2025) to cause the device 2005 to perform various functions (e.g., functions or tasks supporting random access channel configuration for full duplex communications). For example, the device 2005 or a component of the device 2005 may include at least one processor 2035 and at least one memory 2025 coupled with one or more of the at least one processor 2035, the at least one processor 2035 and the at least one memory 2025 configured to perform various functions described herein. The at least one processor 2035 may be an example of a cloud-computing platform (e.g., one or more physical nodes and supporting software such as operating systems, virtual machines, or container instances) that may host the functions (e.g., by executing code 2030) to perform the functions of the device 2005. The at least one processor 2035 may be any one or more suitable processors capable of executing scripts or instructions of one or more software programs stored in the device 2005 (such as within one or more of the at least one memory 2025).

In some examples, the at least one processor 2035 may include multiple processors and the at least one memory 2025 may include multiple memories. One or more of the multiple processors may be coupled with one or more of the multiple memories, which may, individually or collectively, be configured to perform various functions herein. In some examples, the at least one processor 2035 may be a component of a processing system, which may refer to a system (such as a series) of machines, circuitry (including, for example, one or both of processor circuitry (which may include the at least one processor 2035) and memory circuitry (which may include the at least one memory 2025)), or components, that receives or obtains inputs and processes the inputs to produce, generate, or obtain a set of outputs. The processing system may be configured to perform one or more of the functions described herein. For example, the at least one processor 2035 or a processing system including the at least one processor 2035 may be configured to, configurable to, or operable to cause the device 2005 to perform one or more of the functions described herein. Further, as described herein, being “configured to,” being “configurable to,” and being “operable to” may be used interchangeably and may be associated with a capability, when executing code stored in the at least one memory 2025 or otherwise, to perform one or more of the functions described herein.

In some examples, a bus 2040 may support communications of (e.g., within) a protocol layer of a protocol stack. In some examples, a bus 2040 may support communications associated with a logical channel of a protocol stack (e.g., between protocol layers of a protocol stack), which may include communications performed within a component of the device 2005, or between different components of the device 2005 that may be co-located or located in different locations (e.g., where the device 2005 may refer to a system in which one or more of the communications manager 2020, the transceiver 2010, the at least one memory 2025, the code 2030, and the at least one processor 2035 may be located in one of the different components or divided between different components).

In some examples, the communications manager 2020 may manage aspects of communications with a core network 130 (e.g., via one or more wired or wireless backhaul links). For example, the communications manager 2020 may manage the transfer of data communications for client devices, such as one or more UEs 115. In some examples, the communications manager 2020 may manage communications with one or more other network entities 105, and may include a controller or scheduler for controlling communications with UEs 115 (e.g., in cooperation with the one or more other network devices). In some examples, the communications manager 2020 may support an X2 interface within an LTE/LTE-A wireless communications network technology to provide communication between network entities 105.

The communications manager 2020 may support wireless communication in accordance with examples as disclosed herein. For example, the communications manager 2020 is capable of, configured to, or operable to support a means for outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions. The communications manager 2020 is capable of, configured to, or operable to support a means for outputting, to the UE, a second signal that indicates a full-duplex configuration that indicates a set of full-duplex slots, where slots of the set of full-duplex slots are non-overlapping with slots of the set of non-full-duplex slots. The communications manager 2020 is capable of, configured to, or operable to support a means for obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots.

By including or configuring the communications manager 2020 in accordance with examples as described herein, the device 2005 may support techniques for providing ROs in full-duplex slots that are in addition to ROs provided in non-dull-duplex slots, which may provide for reduced latency, enhanced throughput, more efficient utilization of communication resources, improved communication reliability, and improved user experience.

In some examples, the communications manager 2020 may be configured to perform various operations (e.g., receiving, obtaining, monitoring, outputting, transmitting) using or otherwise in cooperation with the transceiver 2010, the one or more antennas 2015 (e.g., where applicable), or any combination thereof. Although the communications manager 2020 is illustrated as a separate component, in some examples, one or more functions described with reference to the communications manager 2020 may be supported by or performed by the transceiver 2010, one or more of the at least one processor 2035, one or more of the at least one memory 2025, the code 2030, or any combination thereof (for example, by a processing system including at least a portion of the at least one processor 2035, the at least one memory 2025, the code 2030, or any combination thereof). For example, the code 2030 may include instructions executable by one or more of the at least one processor 2035 to cause the device 2005 to perform various aspects of random access channel configuration for full duplex communications as described herein, or the at least one processor 2035 and the at least one memory 2025 may be otherwise configured to, individually or collectively, perform or support such operations.

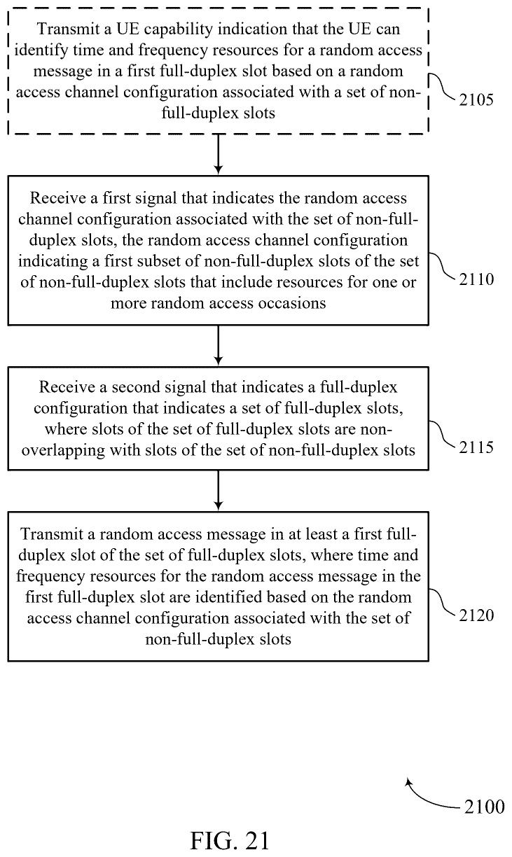

FIG. 21 shows a flowchart illustrating a method 2100 that supports random access channel configuration for full duplex communications in accordance with one or more aspects of the present disclosure. The operations of the method 2100 may be implemented by a UE or its components as described herein. For example, the operations of the method 2100 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

In some examples, at 2105, the method may include transmitting a UE capability indication that the UE can identify the time resources and the frequency resources for one or more random access messages in a first full-duplex slot based on a random access channel configuration associated with a set of non-full-duplex slots. The operations of 2105 may be performed in accordance with examples as disclosed herein. In some examples, aspects of the operations of 2105 may be performed by a capability manager 1545 as described with reference to FIG. 15.

At 2110, the method may include receiving a first signal that indicates the random access channel configuration associated with the set of non-full-duplex slots, the random access channel configuration indicating a first subset of non-full-duplex slots of the set of non-full-duplex slots that include resources for one or more random access occasions. The operations of 2110 may be performed in accordance with examples as disclosed herein. In some examples, aspects of the operations of 2110 may be performed by a RACH configuration manager 1525 as described with reference to FIG. 15.

At 2115, the method may include receiving a second signal that indicates a full-duplex configuration that indicates a set of full-duplex slots, where slots of the set of full-duplex slots are non-overlapping with slots of the set of non-full-duplex slots. The operations of 2115 may be performed in accordance with examples as disclosed herein. In some examples, aspects of the operations of 2115 may be performed by a full-duplex configuration manager 1530 as described with reference to FIG. 15.

At 2120, the method may include transmitting a random access message in at least a first full-duplex slot of the set of full-duplex slots, where time resources and frequency resources for the random access message in the first full-duplex slot are identified based on the random access channel configuration associated with the set of non-full-duplex slots. The operations of 2120 may be performed in accordance with examples as disclosed herein. In some examples, aspects of the operations of 2120 may be performed by a RACH transmission component 1535 as described with reference to FIG. 15.

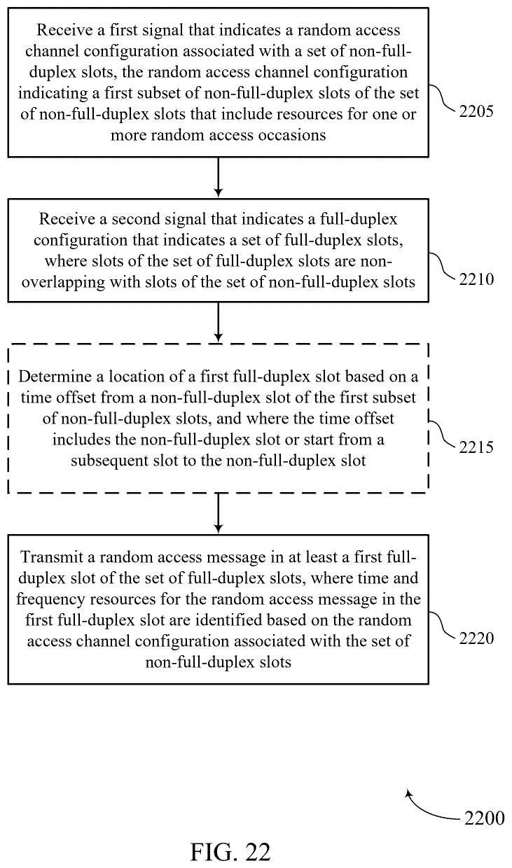

FIG. 22 shows a flowchart illustrating a method 2200 that supports random access channel configuration for full duplex communications in accordance with one or more aspects of the present disclosure. The operations of the method 2200 may be implemented by a UE or its components as described herein. For example, the operations of the method 2200 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2205, the method may include receiving a first signal that indicates a random access channel configuration associated with a set of non-full-duplex slots, the random access channel configuration indicating a first subset of non-full-duplex slots of the set of non-full-duplex slots that include resources for one or more random access occasions. The operations of 2205 may be performed in accordance with examples as disclosed herein. In some examples, aspects of the operations of 2205 may be performed by a RACH configuration manager 1525 as described with reference to FIG. 15.

At 2210, the method may include receiving a second signal that indicates a full-duplex configuration that indicates a set of full-duplex slots, where slots of the set of full-duplex slots are non-overlapping with slots of the set of non-full-duplex slots. The operations of 2210 may be performed in accordance with examples as disclosed herein. In some examples, aspects of the operations of 2210 may be performed by a full-duplex configuration manager 1530 as described with reference to FIG. 15.

In some examples, at 2215, the method may include determining a location of a first full-duplex slot based on a time offset from a non-full-duplex slot of the first subset of non-full-duplex slots, and where the time offset includes the non-full-duplex slot or starts from a subsequent slot to the non-full-duplex slot. The operations of 2215 may be performed in accordance with examples as disclosed herein. In some examples, aspects of the operations of 2215 may be performed by a RACH configuration manager 1525 as described with reference to FIG. 15.

At 2220, the method may include transmitting a random access message in at least the first full-duplex slot of the set of full-duplex slots, where time resources and frequency resources for the random access message in the first full-duplex slot are identified based on the random access channel configuration associated with the set of non-full-duplex slots. The operations of 2220 may be performed in accordance with examples as disclosed herein. In some examples, aspects of the operations of 2220 may be performed by a RACH transmission component 1535 as described with reference to FIG. 15.

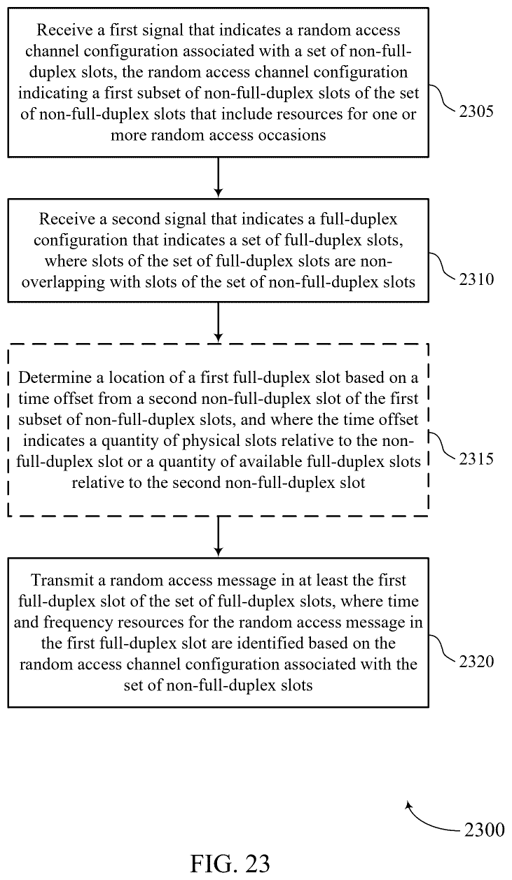

FIG. 23 shows a flowchart illustrating a method 2300 that supports random access channel configuration for full duplex communications in accordance with one or more aspects of the present disclosure. The operations of the method 2300 may be implemented by a UE or its components as described herein. For example, the operations of the method 2300 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2305, the method may include receiving a first signal that indicates a random access channel configuration associated with a set of non-full-duplex slots, the random access channel configuration indicating a first subset of non-full-duplex slots of the set of non-full-duplex slots that include resources for one or more random access occasions. The operations of 2305 may be performed in accordance with examples as disclosed herein. In some examples, aspects of the operations of 2305 may be performed by a RACH configuration manager 1525 as described with reference to FIG. 15.

At 2310, the method may include receiving a second signal that indicates a full-duplex configuration that indicates a set of full-duplex slots, where slots of the set of full-duplex slots are non-overlapping with slots of the set of non-full-duplex slots. The operations of 2310 may be performed in accordance with examples as disclosed herein. In some examples, aspects of the operations of 2310 may be performed by a full-duplex configuration manager 1530 as described with reference to FIG. 15.

In some examples, at 2315, the method may include determining a location of a first full-duplex slot based on a time offset from a non-full-duplex slot of the first subset of non-full-duplex slots, and where the time offset indicates a quantity of physical slots relative to the non-full-duplex slot or a quantity of available full-duplex slots relative to the non-full-duplex slot. The operations of 2315 may be performed in accordance with examples as disclosed herein. In some examples, aspects of the operations of 2315 may be performed by a RACH configuration manager 1525 as described with reference to FIG. 15.

At 2320, the method may include transmitting a random access message in at least the first full-duplex slot of the set of full-duplex slots, where time resources and frequency resources for the random access message in the first full-duplex slot are identified based on the random access channel configuration associated with the set of non-full-duplex slots. The operations of 2320 may be performed in accordance with examples as disclosed herein. In some examples, aspects of the operations of 2320 may be performed by a RACH transmission component 1535 as described with reference to FIG. 15.

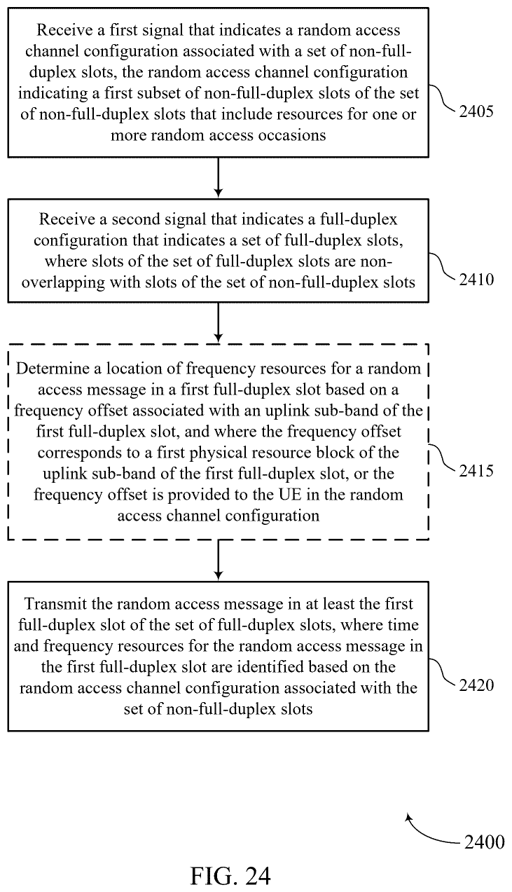

FIG. 24 shows a flowchart illustrating a method 2400 that supports random access channel configuration for full duplex communications in accordance with one or more aspects of the present disclosure. The operations of the method 2400 may be implemented by a UE or its components as described herein. For example, the operations of the method 2400 may be performed by a UE 115 as described with reference to FIGS. 1 through 16. In some examples, a UE may execute a set of instructions to control the functional elements of the UE to perform the described functions. Additionally, or alternatively, the UE may perform aspects of the described functions using special-purpose hardware.

At 2405, the method may include receiving a first signal that indicates a random access channel configuration associated with a set of non-full-duplex slots, the random access channel configuration indicating a first subset of non-full-duplex slots of the set of non-full-duplex slots that include resources for one or more random access occasions. The operations of 2405 may be performed in accordance with examples as disclosed herein. In some examples, aspects of the operations of 2405 may be performed by a RACH configuration manager 1525 as described with reference to FIG. 15.

At 2410, the method may include receiving a second signal that indicates a full-duplex configuration that indicates a set of full-duplex slots, where slots of the set of full-duplex slots are non-overlapping with slots of the set of non-full-duplex slots. The operations of 2410 may be performed in accordance with examples as disclosed herein. In some examples, aspects of the operations of 2410 may be performed by a full-duplex configuration manager 1530 as described with reference to FIG. 15.

In some examples, at 2415, the method may include determining a location of frequency resources for a random access message in the first full-duplex slot based on a frequency offset associated with an uplink sub-band of the first full-duplex slot, and where the frequency offset corresponds to a first physical resource block of the uplink sub-band of the first full-duplex slot, or the frequency offset is provided to the UE in the random access channel configuration. The operations of 2415 may be performed in accordance with examples as disclosed herein. In some examples, aspects of the operations of 2415 may be performed by a RACH configuration manager 1525 as described with reference to FIG. 15.

At 2420, the method may include transmitting the random access message in at least the first full-duplex slot of the set of full-duplex slots, where time resources and frequency resources for the random access message in the first full-duplex slot are identified based on the random access channel configuration associated with the set of non-full-duplex slots. The operations of 2420 may be performed in accordance with examples as disclosed herein. In some examples, aspects of the operations of 2420 may be performed by a RACH transmission component 1535 as described with reference to FIG. 15.

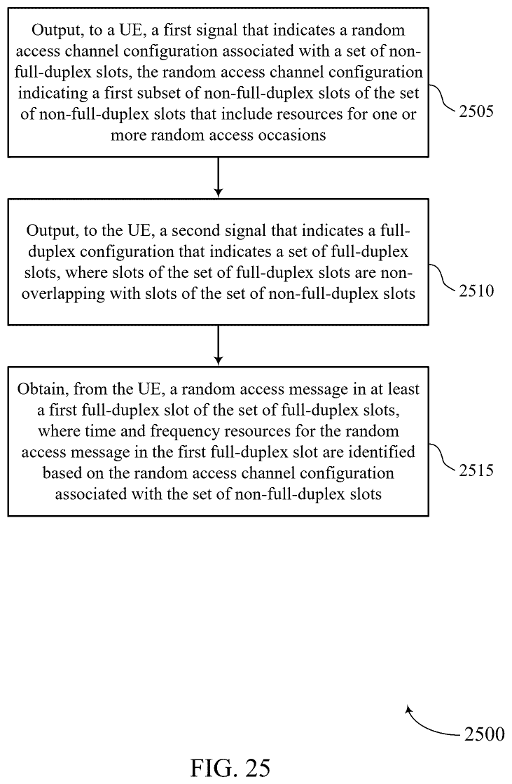

FIG. 25 shows a flowchart illustrating a method 2500 that supports random access channel configuration for full duplex communications in accordance with one or more aspects of the present disclosure. The operations of the method 2500 may be implemented by a network entity or its components as described herein. For example, the operations of the method 2500 may be performed by a network entity as described with reference to FIGS. 1 through 12 and 17 through 20. In some examples, a network entity may execute a set of instructions to control the functional elements of the network entity to perform the described functions. Additionally, or alternatively, the network entity may perform aspects of the described functions using special-purpose hardware.

At 2505, the method may include outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions. The operations of 2505 may be performed in accordance with examples as disclosed herein. In some examples, aspects of the operations of 2505 may be performed by a RACH configuration manager 1925 as described with reference to FIG. 19.

At 2510, the method may include outputting, to the UE, a second signal that indicates a full-duplex configuration that indicates a set of full-duplex slots, where slots of the set of full-duplex slots are non-overlapping with slots of the set of non-full-duplex slots. The operations of 2510 may be performed in accordance with examples as disclosed herein. In some examples, aspects of the operations of 2510 may be performed by a full-duplex configuration manager 1930 as described with reference to FIG. 19.

At 2515, the method may include obtaining, from the UE, a random access message in at least a first full-duplex slot of the set of full-duplex slots, where time resources and frequency resources for the random access message in the first full-duplex slot are identified based on the random access channel configuration associated with the set of non-full-duplex slots. The operations of 2515 may be performed in accordance with examples as disclosed herein. In some examples, aspects of the operations of 2515 may be performed by a RACH reception component 1935 as described with reference to FIG. 19.

The following provides an overview of aspects of the present disclosure:

Aspect 1: A method for wireless communication at a UE, comprising: receiving a first signal that indicates a random access channel configuration associated with a set of non-full-duplex slots, the random access channel configuration indicating a first subset of non-full-duplex slots of the set of non-full-duplex slots that include resources for one or more random access occasions; receiving a second signal that indicates a full-duplex configuration that indicates a set of full-duplex slots, wherein slots of the set of full-duplex slots are non-overlapping with slots of the set of non-full-duplex slots; and transmitting a random access message in at least a first full-duplex slot of the set of full-duplex slots, wherein time resources and frequency resources for the random access message in the first full-duplex slot are identified based at least in part on the random access channel configuration associated with the set of non-full-duplex slots.

Aspect 2: The method of aspect 1, further comprising: identifying, based at least in part on a time offset from one or more slots of the first subset of non-full-duplex slots, a second subset of full-duplex slots within the set of full-duplex slots that include one or more random access occasions that are available for transmission of the random access message.

Aspect 3: The method of aspect 2, wherein the second subset of full-duplex slots are identified based at least in part on a mapping from the first subset of non-full-duplex slots, and wherein the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots.

Aspect 4: The method of any of aspects 1 through 3, further comprising: determining a location of the first full-duplex slot based at least in part on a time offset from a non-full-duplex slot of the first subset of non-full-duplex slots, and wherein the time offset includes the non-full-duplex slot or starts from a subsequent slot to the non-full-duplex slot.

Aspect 5: The method of any of aspects 1 through 4, wherein the set of full-duplex slots includes at least two full-duplex slots that are mapped to a first non-full-duplex slot of the first subset of non-full-duplex slots.

Aspect 6: The method of any of aspects 1 through 5, further comprising: determining a location of the first full-duplex slot based at least in part on a time offset from a non-full-duplex slot of the first subset of non-full-duplex slots, and wherein the time offset indicates a quantity of physical slots relative to the non-full-duplex slot or a quantity of available full-duplex slots relative to the second non-full-duplex slot.

Aspect 7: The method of aspect 6, wherein the time offset indicates a positive or negative quantity of slots relative to the second non-full-duplex slot.

Aspect 8: The method of any of aspects 1 through 7, further comprising: identifying one or more random access occasions in the first full-duplex slot based at least in part on a time offset from a random access channel occasion in a first non-full-duplex slot of the first subset of non-full-duplex slots, wherein the first full-duplex slot includes the one or more random access occasions irrespective of whether the first non-full-duplex slot is a valid uplink slot.

Aspect 9: The method of aspect 8, further comprising: determining a location of the one or more random access occasions in the first full-duplex slot based at least in part on a time offset from one or more random access occasions in the first subset of non-full-duplex slots, and wherein the time offset indicates a quantity of slots or symbols relative to the one or more random access occasions in one or more non-full-duplex symbols in the first subset of non-full-duplex slots.

Aspect 10: The method of any of aspects 1 through 9, further comprising: identifying one or more random access occasions for a random access channel transmission in the first full-duplex slot based at least in part on a time offset only from a valid random access occasion in the first subset of non-full-duplex slots.

Aspect 11: The method of aspect 10, further comprising: determining a location of the one or more random access occasions in the first full-duplex slot based at least in part on a time offset from one or more random access occasions in the first subset of non-full-duplex slots, and wherein the time offset indicates a quantity of slots or symbols relative to the one or more random access occasions in one or more non-full-duplex symbols in the first subset of non-full-duplex slots.

Aspect 12: The method of any of aspects 1 through 11, further comprising: determining a location of the first full-duplex slot based at least in part on a time offset from a non-full-duplex slot of the first subset of non-full-duplex slots, and wherein the time offset is a defined offset value or is provided to the UE in the random access channel configuration.

Aspect 13: The method of any of aspects 1 through 12, further comprising: determining a location of the frequency resources for the random access message in the first full-duplex slot based at least in part on a frequency offset associated with an uplink sub-band of the first full-duplex slot, and wherein the frequency offset corresponds to a first physical resource block of the uplink sub-band of the first full-duplex slot, or the frequency offset is provided to the UE in the random access channel configuration.

Aspect 14: The method of any of aspects 1 through 13, wherein the first full-duplex slot includes an uplink sub-band that includes frequency resources for at least two random access occasions, the random access message transmitted using frequency resources of one of the at least two random access occasions, and wherein: the at least two random access occasions are frequency division multiplexed within the uplink sub-band in accordance with a frequency division multiplexing configuration provided with the random access channel configuration associated with a set of non-full-duplex slots, the at least two random access occasions are frequency division multiplexed within the uplink sub-band based at least in part on a bandwidth of the uplink sub-band, or the at least two random access occasions are frequency division multiplexed within the uplink sub-band in accordance with a frequency division multiplexing configuration provided with the full-duplex configuration.

Aspect 15: The method of any of aspects 1 through 14, further comprising: formatting a sequence of the random access message in accordance with a same format indicated in the random access channel configuration, or in accordance with a format indicated in the full-duplex configuration.

Aspect 16: The method of any of aspects 1 through 15, wherein a quantity of full-duplex slots of the set of full-duplex slots that are configured for transmission of the random access message is signaled to the UE, or is determined based at least in part on a quantity of non-full-duplex slots that are configured for transmission of random access messages.

Aspect 17: The method of any of aspects 1 through 16, wherein a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots.

Aspect 18: The method of any of aspects 1 through 17, wherein a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

Aspect 19: The method of any of aspects 1 through 18, wherein a time duration of one or more random access occasions within the first full-duplex slot is a same duration as, or a different duration than, a time duration of the one or more random access occasions of the first subset of non-full-duplex slots, based at least in part on whether a same or different random access channel sequence is configured for full-duplex slots and non-full-duplex slots.

Aspect 20: The method of any of aspects 1 through 19, wherein the first full-duplex slot includes time resources for two or more random access occasions and frequency resources for the two or more random access occasions, and wherein a time gap and a frequency gap between consecutive random access occasions are each zero unless configured to a non-zero value.

Aspect 21: The method of any of aspects 1 through 20, further comprising: receiving mapping information that indicates a correspondence between one or more random access occasions within the first full-duplex slot and one or more synchronization signal blocks, and wherein the mapping information is provided separately from other mapping information associated with non-full-duplex slots.

Aspect 22: The method of any of aspects 1 through 21, further comprising: receiving mapping information that indicates a correspondence between one or more random access occasions and one or more synchronization signal blocks, and wherein the mapping information applies to both full-duplex slots and non-full-duplex slots.

Aspect 23: The method of any of aspects 1 through 22, further comprising: transmitting a UE capability indication that the UE can identify the time resources and the frequency resources for the random access message in the first full-duplex slot based at least in part on the random access channel configuration associated with the set of non-full-duplex slots.

Aspect 24: A method for wireless communication at a network entity, comprising: outputting, to a UE, a first signal that indicates a random access channel configuration associated with a set of non-full-duplex slots, the random access channel configuration indicating a first subset of non-full-duplex slots of the set of non-full-duplex slots that include resources for one or more random access occasions; outputting, to the UE, a second signal that indicates a full-duplex configuration that indicates a set of full-duplex slots, wherein slots of the set of full-duplex slots are non-overlapping with slots of the set of non-full-duplex slots; and obtaining, from the UE, a random access message in at least a first full-duplex slot of the set of full-duplex slots, wherein time resources and frequency resources for the random access message in the first full-duplex slot are identified based at least in part on the random access channel configuration associated with the set of non-full-duplex slots.

Aspect 25: The method of aspect 24, wherein a second subset of full-duplex slots within the set of full-duplex slots include one or more random access occasions that are available for transmission of the random access message, and wherein the second subset of full-duplex slots are determined based at least in part on a time offset from one or more slots of the first subset of non-full-duplex slots.

Aspect 26: The method of aspect 25, wherein the second subset of full-duplex slots are identified based at least in part on a mapping from the first subset of non-full-duplex slots, and wherein the mapping provides a one-to-one mapping between each slot of the first subset of non-full-duplex slots and each slot of the second subset of full-duplex slots, or the mapping provides a one-to-many mapping between a second slot of the first subset of non-full-duplex slots and two or more slots of the second subset of full-duplex slots.

Aspect 27: The method of any of aspects 24 through 26, wherein a location of the first full-duplex slot is determined based at least in part on a time offset from a non-full-duplex slot of the first subset of non-full-duplex slots, and wherein the time offset includes the non-full-duplex slot or starts from a subsequent slot to the second non-full-duplex slot.

Aspect 28: The method of any of aspects 24 through 27, wherein the set of full-duplex slots includes at least two full-duplex slots that are mapped to a first non-full-duplex slot of the first subset of non-full-duplex slots.

Aspect 29: The method of any of aspects 24 through 28, wherein a location of the first full-duplex slot is determined based at least in part on a time offset from a non-full-duplex slot of the first subset of non-full-duplex slots, and wherein the time offset indicates a quantity of physical slots relative to the non-full-duplex slot or a quantity of available full-duplex slots relative to the second non-full-duplex slot.

Aspect 30: The method of aspect 29, wherein the time offset indicates a positive or negative quantity of slots relative to the second non-full-duplex slot.

Aspect 31: The method of any of aspects 24 through 30, wherein the first full-duplex slot includes one or more random access occasions that are determined based at least in part on a time offset from a random access channel occasion in a first non-full-duplex slot of the first subset of non-full-duplex slots, wherein the first full-duplex slot includes the one or more random access occasions irrespective of whether the first non-full-duplex slot is a valid uplink slot.

Aspect 32: The method of any of aspects 24 through 31, wherein the first full-duplex slot includes one or more random access occasions for a random access channel transmission that is based at least in part on a time offset only from a valid random access occasion in the first subset of non-full-duplex slots.

Aspect 33: The method of aspect 32, wherein a location of the one or more random access occasions in the first full-duplex slot is based at least in part on a time offset from one or more random access occasions in the first subset of non-full-duplex slots, and wherein the time offset indicates a quantity of slots or symbols relative to the one or more random access occasions in one or more non-full-duplex symbols in the first subset of non-full-duplex slots.

Aspect 34: The method of any of aspects 24 through 33, wherein a location of the first full-duplex slot is determined based at least in part on a time offset from a non-full-duplex slot of the first subset of non-full-duplex slots, and wherein the time offset is a defined offset value or is provided to the UE in the random access channel configuration.

Aspect 35: The method of any of aspects 24 through 34, wherein a location of the frequency resources for the random access message in the first full-duplex slot is determined based at least in part on a frequency offset associated with an uplink sub-band of the first full-duplex slot, and wherein the frequency offset corresponds to a first physical resource block of the uplink sub-band of the first full-duplex slot, or the frequency offset is provided to the UE in the random access channel configuration.

Aspect 36: The method of any of aspects 24 through 35, wherein the first full-duplex slot includes an uplink sub-band that includes frequency resources for at least two random access occasions, the random access message transmitted using frequency resources of one of the at least two random access occasions, and wherein: the at least two random access occasions are frequency division multiplexed within the uplink sub-band in accordance with a frequency division multiplexing configuration provided with the random access channel configuration associated with a set of non-full-duplex slots, the at least two random access occasions are frequency division multiplexed within the uplink sub-band based at least in part on a bandwidth of the uplink sub-band, or the at least two random access occasions are frequency division multiplexed within the uplink sub-band in accordance with a frequency division multiplexing configuration provided with the full-duplex configuration.

Aspect 37: The method of any of aspects 24 through 36, wherein a sequence of the random access message is formatted in accordance with a same format indicated in the random access channel configuration, or in accordance with a format indicated in the full-duplex configuration.

Aspect 38: The method of any of aspects 24 through 37, wherein a quantity of full-duplex slots of the set of full-duplex slots that are configured for transmission of the random access message is signaled to the UE, or is determined based at least in part on a quantity of non-full-duplex slots that are configured for transmission of random access messages.

Aspect 39: The method of any of aspects 24 through 38, wherein a first quantity of random access occasions that are available for transmission of the random access message in the first full-duplex slot is a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots.

Aspect 40: The method of any of aspects 24 through 39, wherein a first quantity of random access occasions that are available for transmission of the random access message in the first full-duplex slot is scaled relative to a second quantity of random access occasions that are available for transmission of random access messages in the first subset of non-full-duplex slots when a different random access channel sequence is configured for full-duplex slots and non-full-duplex slots.

Aspect 41: The method of any of aspects 24 through 40, wherein a time duration of one or more random access occasions within the first full-duplex slot is a same duration as, or a different duration than, a time duration of the one or more random access occasions of the first subset of non-full-duplex slots, based at least in part on whether a same or different random access channel sequence is configured for full-duplex slots and non-full-duplex slots.

Aspect 42: The method of any of aspects 24 through 41, wherein the first full-duplex slot includes time resources for two or more random access occasions and frequency resources for the two or more random access occasions, and wherein a time gap and a frequency gap between consecutive random access occasions are each zero unless configured to a non-zero value.

Aspect 43: The method of any of aspects 24 through 42, further comprising: outputting mapping information that indicates a correspondence between one or more random access occasions within the first full-duplex slot and one or more synchronization signal blocks, and wherein the mapping information is provided separately from other mapping information associated with non-full-duplex slots.

Aspect 44: The method of any of aspects 24 through 43, further comprising: outputting mapping information that indicates a correspondence between one or more random access occasions and one or more synchronization signal blocks, and wherein the mapping information applies to both full-duplex slots and non-full-duplex slots.

Aspect 45: A UE for wireless communication, comprising one or more memories storing processor-executable code, and one or more processors coupled with the one or more memories and individually or collectively operable to execute the code to cause the UE to perform a method of any of aspects 1 through 23.

Aspect 46: A UE for wireless communication, comprising at least one means for performing a method of any of aspects 1 through 23.

Aspect 47: A non-transitory computer-readable medium storing code for wireless communication, the code comprising instructions executable by one or more processors to perform a method of any of aspects 1 through 23.

Aspect 48: A network entity for wireless communication, comprising one or more memories storing processor-executable code, and one or more processors coupled with the one or more memories and individually or collectively operable to execute the code to cause the network entity to perform a method of any of aspects 24 through 44.

Aspect 49: A network entity for wireless communication, comprising at least one means for performing a method of any of aspects 24 through 44.

Aspect 50: A non-transitory computer-readable medium storing code for wireless communication, the code comprising instructions executable by one or more processors to perform a method of any of aspects 24 through 44.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first signal that indicates a random access channel configuration associated with a set of non-full-duplex slots, the random access channel configuration indicating a first subset of non-full-duplex slots of the set of non-full-duplex slots that include resources for one or more random access occasions;
receive a second signal that indicates a full-duplex configuration that indicates a set of full-duplex slots, wherein slots of the set of full-duplex slots are non-overlapping with slots of the set of non-full-duplex slots; and
transmit a random access message in at least a first full-duplex slot of the set of full-duplex slots, wherein time resources and frequency resources for the random access message in the first full-duplex slot are identified based at least in part on the random access channel configuration associated with the set of non-full-duplex slots.

2. The UE of claim 1, wherein the one or more processors are individually or collectively further operable to execute the code to cause the UE to:
determine a location of the frequency resources for the random access message in the first full-duplex slot based at least in part on a frequency offset associated with an uplink sub-band of the first full-duplex slot, wherein the frequency offset corresponds to a first physical resource block of the uplink sub-band of the first full-duplex slot.

3. The UE of claim 1, wherein the one or more processors are individually or collectively further operable to execute the code to cause the UE to:
identifying, based at least in part on a time offset from one or more slots of the first subset of non-full-duplex slots, a second subset of full-duplex slots within the set of full-duplex slots that include one or more random access occasions that are available for transmission of the random access message.

4. The UE of claim 1, wherein the one or more processors are individually or collectively further operable to execute the code to cause the UE to:
determine a location of the first full-duplex slot based at least in part on a time offset from a non-full-duplex slot of the first subset of non-full-duplex slots, and wherein the time offset includes the non-full-duplex slot or starts from a subsequent slot to the non-full-duplex slot.

5. The UE of claim 1, wherein the one or more processors are individually or collectively further operable to execute the code to cause the UE to:
determine a location of the first full-duplex slot based at least in part on a time offset from a non-full-duplex slot of the first subset of non-full-duplex slots, and wherein the time offset indicates a quantity of physical slots relative to the non-full-duplex slot or a quantity of available full-duplex slots relative to the non-full-duplex slot.

6. The UE of claim 1, wherein the one or more processors are individually or collectively further operable to execute the code to cause the UE to:
identify one or more random access occasions in the first full-duplex slot based at least in part on a time offset from a random access channel occasion in a first non-full-duplex slot of the first subset of non-full-duplex slots, wherein the first full-duplex slot includes the one or more random access occasions irrespective of whether the first non-full-duplex slot is a valid uplink slot.

7. The UE of claim 1, wherein the one or more processors are individually or collectively further operable to execute the code to cause the UE to:
determine a location of the first full-duplex slot based at least in part on a time offset from a non-full-duplex slot of the first subset of non-full-duplex slots, and wherein the time offset is a defined offset value or is provided to the UE in the random access channel configuration.

8. The UE of claim 1, wherein the one or more processors are individually or collectively further operable to execute the code to cause the UE to:
determine a location of the frequency resources for the random access message in the first full-duplex slot based at least in part on a frequency offset associated with an uplink sub-band of the first full-duplex slot, wherein the frequency offset is provided to the UE in the random access channel configuration.

9. The UE of claim 1, wherein:
the first full-duplex slot includes an uplink sub-band that includes frequency resources for at least two random access occasions, the random access message transmitted using frequency resources of one of the at least two random access occasions, and wherein:
the at least two random access occasions are frequency division multiplexed within the uplink sub-band in accordance with a frequency division multiplexing configuration provided with the random access channel configuration associated with a set of non-full-duplex slots,
the at least two random access occasions are frequency division multiplexed within the uplink sub-band based at least in part on a bandwidth of the uplink sub-band, or
the at least two random access occasions are frequency division multiplexed within the uplink sub-band in accordance with a frequency division multiplexing configuration provided with the full-duplex configuration.

10. The UE of claim 1, wherein the one or more processors are individually or collectively further operable to execute the code to cause the UE to:
format a sequence of the random access message in accordance with a same format indicated in the random access channel configuration, or in accordance with a format indicated in the full-duplex configuration.

11. The UE of claim 1, wherein a quantity of full-duplex slots of the set of full-duplex slots that are configured for transmission of the random access message is signaled to the UE, or is determined based at least in part on a quantity of non-full-duplex slots that are configured for transmission of random access messages.

12. The UE of claim 1, wherein a first quantity of random access occasions that are available for transmission of the random access message in the first full-duplex slot is:
a same quantity as, a subset of, or an integer multiple of, a second quantity of random access occasions that are available for transmission of the random access message in a first non-full-duplex slot of the first subset of non-full-duplex slots when a same random access channel sequence is configured for full-duplex slots and non-full-duplex slots; or
scaled relative to a second quantity of random access occasions that are available for transmission of random access messages in the first subset of non-full-duplex slots when a different random access channel sequence is configured for full-duplex slots and non-full-duplex slots.

13. The UE of claim 1, wherein a time duration of one or more random access occasions within the first full-duplex slot is a same duration as, or a different duration than, a time duration of the one or more random access occasions of the first subset of non-full-duplex slots, based at least in part on whether a same or different random access channel sequence is configured for full-duplex slots and non-full-duplex slots.

14. The UE of claim 1, wherein the one or more processors are individually or collectively further operable to execute the code to cause the UE to:
receive mapping information that indicates a correspondence between one or more random access occasions and one or more synchronization signal blocks, and wherein:
the mapping information is provided separately from other mapping information associated with non-full-duplex slots; or
the mapping information applies to both full-duplex slots and non-full-duplex slots.

15. The UE of claim 1, wherein the one or more processors are individually or collectively further operable to execute the code to cause the UE to:
transmit a UE capability indication that the UE can identify the time resources and the frequency resources for the random access message in the first full-duplex slot based at least in part on the random access channel configuration associated with the set of non-full-duplex slots.

16. A network entity, comprising:
one or more memories storing processor-executable code; and
one or more processors coupled with the one or more memories and individually or collectively operable to execute the code to cause the network entity to:
output, to a user equipment (UE), a first signal that indicates a random access channel configuration associated with a set of non-full-duplex slots, the random access channel configuration indicating a first subset of non-full-duplex slots of the set of non-full-duplex slots that include resources for one or more random access occasions;
output, to the UE, a second signal that indicates a full-duplex configuration that indicates a set of full-duplex slots, wherein slots of the set of full-duplex slots are non-overlapping with slots of the set of non-full-duplex slots; and
obtain, from the UE, a random access message in at least a first full-duplex slot of the set of full-duplex slots, wherein time resources and frequency resources for the random access message in the first full-duplex slot are identified based at least in part on the random access channel configuration associated with the set of non-full-duplex slots.

17. The network entity of claim 16, wherein a location of the frequency resources for the random access message in the first full-duplex slot is based at least in part on a frequency offset associated with an uplink sub-band of the first full-duplex slot, wherein the frequency offset corresponds to a first physical resource block of the uplink sub-band of the first full-duplex slot.

18. The network entity of claim 16, wherein a second subset of full-duplex slots within the set of full-duplex slots include one or more random access occasions that are available for transmission of the random access message, and wherein the second subset of full-duplex slots are determined based at least in part on a time offset from one or more slots of the first subset of non-full-duplex slots.

19. A method for wireless communication at a user equipment (UE), comprising:
receiving a first signal that indicates a random access channel configuration associated with a set of non-full-duplex slots, the random access channel configuration indicating a first subset of non-full-duplex slots of the set of non-full-duplex slots that include resources for one or more random access occasions;
receiving a second signal that indicates a full-duplex configuration that indicates a set of full-duplex slots, wherein slots of the set of full-duplex slots are non-overlapping with slots of the set of non-full-duplex slots; and
transmitting a random access message in at least a first full-duplex slot of the set of full-duplex slots, wherein time resources and frequency resources for the random access message in the first full-duplex slot are identified based at least in part on the random access channel configuration associated with the set of non-full-duplex slots.

20. The method of claim 19, further comprising:
determine a location of the frequency resources for the random access message in the first full-duplex slot based at least in part on a frequency offset associated with an uplink sub-band of the first full-duplex slot, wherein the frequency offset corresponds to a first physical resource block of the uplink sub-band of the first full-duplex slot.
